(19) United States
(12) Patent Application Publication
(10) Pub. No.: US 2024/0117104 A1
(43) Pub. Date: Apr. 11, 2024

(54) FUNCTIONALIZED IONIC POLYMERS AND USES THEREOF

(71) Applicants: Jennifer Imbrogno, Richmond, CA (US); Andrew Davis, Richmond, CA (US); Ethan Wesley Kent, Webster, NY (US)

(72) Inventors: Jennifer Imbrogno, Richmond, CA (US); Andrew Davis, Richmond, CA (US); Ethan Wesley Kent, Webster, NY (US)

(21) Appl. No.: 18/241,019

(22) Filed: Aug. 31, 2023

Related U.S. Application Data
(60) Provisional application No. 63/376,405, filed on Sep. 20, 2022.

(51) Int. Cl. C08G 61/12; H01M 10/0565

(52) U.S. Cl. CPC C08G 61/121; C08G 61/127; H01M 10/0565; H01M 2300/0082

(57) ABSTRACT

The disclosure relates to compositions comprising a first structure of the formula:

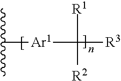

or a salt thereof, wherein R¹, R², R³, Ar¹, and n are defined herein. Materials, devices, and methods of using such compositions are also described.

### CROSS-REFERENCE TO RELATED APPLICATIONS

This application claims the benefit of U.S. Provisional Appl. Ser. No. 63/376,405, filed Sep. 20, 2022, which is incorporated by reference as if fully set forth herein.

### BACKGROUND

One component of an electrochemical cell includes a polymer-based electrolyte membrane. The physical and chemical characteristics of the polymeric membrane can affect performance of such cells.

### SUMMARY

The disclosure relates to compositions including a first polymeric structure including an ionizable moiety or an ionic moiety. The compositions can include a polymer, a copolymer, a polymeric blend, a block copolymer, or other polymer-based forms.

The disclosure also relates to a method of making the compositions described herein, wherein a terminating agent (e.g., toluene) is added to a polymerization reaction mixture in such a way that any resulting exotherm is minimized or eliminated. Thereby, the present invention also provides a safe and efficient strategy for making polymers of the type described herein. In some embodiments, the addition of the terminating agent to the polymerization reaction results in an exotherm. For example, when the polymerization is terminated by methanol, an exotherm is observed. In some embodiments, when the termination of the polymerization reaction is carried out in methanol, the reaction temperature can increase, for example, up to about 40° C. In contrast, when the polymerization is terminated with toluene and subsequently precipitated in methanol, the reaction temperature remains at room temperature (e.g., at 25° C.). One strategy to modulate the exotherm observed is to perform the termination over an extended period of time.

Those with ordinary skill in the art will understand that the polydispersity index (PD)I describes the molecular weight distribution of a particular sample, thus as the PDI approaches unity (i.e., the PDI is closer to 1.0), the more uniform the distribution. In some embodiments, when the polymerization is terminated with toluene, the polydispersity index (PDI) of the resulting polymer can be less than 2.7, less than 2.5, less than 2.6, less than 2.4, less than 2.3, less than 2.2, less than 2.1 or even less than 2.0 as determined by gel permeation chromatography (GPC). In some embodiments, when methanol is used to terminate the polymerization reaction the PDI of the resultant polymers may be higher (e.g., 2.7 or as high as 3.3) when compared to the PDI of the toluene-terminated polymers. In some embodiments, when methanol is used to terminate the polymerization reaction, the PDI of the resultant polymers may be comparable to the PDI of the toluene-terminated polymers. In some embodiments, the PDI of the polymers described by the invention can be from 1 to 3, such as from 2 to 3, 2.5 to 3, 2.1 to 2.7, 2.2 to 2.6 or 2 to 2.5.

### Definitions

As used herein, the term “about” means +/−10% of any recited value. As used herein, this term modifies any recited value, range of values, or endpoints of one or more ranges.

As used herein, the terms “top,” “bottom,” “upper,” “lower,” “above,” and “below” are used to provide a relative relationship between structures. The use of these terms does not indicate or require that a particular structure must be located at a particular location in the apparatus.

By “aliphatic” is meant a hydrocarbon group having at least one carbon atom to 50 carbon atoms (C₁₋₅₀), such as one to 25 carbon atoms (C₁₋₂₅), or one to ten carbon atoms (C₁₋₁₀), and which includes alkanes (or alkyl), alkenes (or alkenyl), alkynes (or alkynyl), including cyclic versions thereof, and further including straight- and branched-chain arrangements, and all stereo and position isomers as well. Such an aliphatic can be unsubstituted or substituted with one or more groups, such as groups described herein for an alkyl group.

The term “acyl,” or “alkanoyl.” as used interchangeably herein, represents an alkyl group, as defined herein, or hydrogen attached to the parent molecular group through a carbonyl group, as defined herein. This group is exemplified by formyl, acetyl, propionyl, butanoyl, and the like. The alkanoyl group can be substituted or unsubstituted. For example, the alkanoyl group can be substituted with one or more substitution groups, as described herein for alkyl. In some embodiments, the unsubstituted acyl group is a C₂₋₇ acyl or alkanoyl group. In particular embodiments, the alkanoyl group is —C(O)-Ak, in which Ak is an alkyl group, as defined herein.

By “alkoxy” is meant —OR, where R is an optionally substituted alkyl group, as described herein. Exemplary alkoxy groups include methoxy, ethoxy, butoxy, trihaloalkoxy, such as trifluoromethoxy, etc. The alkoxy group can be substituted or unsubstituted. For example, the alkoxy group can be substituted with one or more substitution groups, as described herein for alkyl. Exemplary unsubstituted alkoxy groups include C₁₋₃, C₁₋₅, C₁₋₁₂, C₁₋₁₆, C₁₋₁₈, C₁₋₂₀, or C₁₋₂₄ alkoxy groups.

By “alkoxyalkyl” is meant an alkyl group, as defined herein, which is substituted with an alkoxy group, as defined herein. Exemplary unsubstituted alkoxyalkyl groups include between 2 to 12 carbons (C₂₋₁₂ alkoxyalkyl), as well as those having an alkyl group with 1 to 6 carbons and an alkoxy group with 1 to 6 carbons (e.g., C₁₋₆ alkoxy-C₁₋₆ alkyl).

By “alkyl” and the prefix“alk” is meant a branched or unbranched saturated hydrocarbon group of 1 to 24 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dodecyl, tetradecyl, hexadecyl, eicosyl, tetracosyl, and the like. The alkyl group can be cyclic (e.g., C₃₋₂₄ cycloalkyl) or acyclic. The alkyl group can be branched or unbranched. The alkyl group can also be substituted or unsubstituted. For example, the alkyl group can be substituted with one, two, three or, in the case of alkyl groups of two carbons or more, four substituents independently selected from the group consisting of: (1) C₁₋₆ alkoxy (e.g., —O-Ak, wherein Ak is optionally substituted C₁₋₆ alkyl); (2) C₁₋₆ alkylsulfinyl (e.g., —S(O)-Ak, wherein Ak is optionally substituted C₁₋₆ alkyl); (3) C₁₋₆ alkylsulfonyl (e.g., —SO₂-Ak, wherein Ak is optionally substituted C₁₋₆ alkyl); (4) amino (e.g., —NR^{N1}R^{N2}, where each of R^{N1} and R^{N2} is, independently, H or optionally substituted alkyl, or R^{N1} and R^{N2}, taken together with the nitrogen atom to which each are attached, form a heterocyclyl group); (5) aryl; (6) arylalkoxy (e.g., —O-L-Ar, wherein L is a bivalent form of optionally substituted alkyl and Ar is optionally substituted aryl); (7) aryloyl (e.g., —C(O)—Ar, wherein Ar is optionally substituted aryl); (8) azido (e.g., —N₃); (9) cyano (e.g., —CN); (10) carboxyaldehyde (e.g., —C(O)H); (11) C₃₋₈ cycloalkyl (e.g., a monovalent saturated or unsaturated non-aromatic cyclic C₃₋₈ hydrocarbon group); (12) halo (e.g., F, Cl, Br, or I); (13) heterocyclyl (e.g., a 5-, 6-or 7-membered ring, unless otherwise specified, containing one, two, three, or four non-carbon heteroatoms, such as nitrogen, oxygen, phosphorous, sulfur, or halo); (14) heterocyclyloxy (e.g., —O-Het, wherein Het is heterocyclyl, as described herein); (15) heterocyclyloyl (e.g., —C(O)-Het, wherein Het is heterocyclyl, as described herein); (16) hydroxyl (e.g., —OH); (17) N-protected amino; (18) nitro (e.g., —NO2); (19) oxo (e.g., ═O) or hydroxyimino (e.g., ═N—OH); (20) C₃₋₈ spirocyclyl (e.g., an alkylene or heteroalkylene diradical, both ends of which are bonded to the same carbon atom of the parent group); (21) C₁₋₆ thioalkoxy (e.g., —S-Ak, wherein Ak is optionally substituted C₁₋₆ alkyl); (22) thiol (e.g., —SH); (23) —CO₂R^{A}, where R^{A} is selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); (24) —C(O)NR^{B}R^{C}, where each of R^{B} and R^{C} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); (25) —SO₂R^{D}, where R^{D} is selected from the group consisting of (a) C₁₋₆ alkyl, (b) C₄₋₁₈ aryl, and (c) (C₄₋₁₈ aryl) C₁₋₆ alkyl (e.g., -L-Ar, wherein L is a bivalent form of optionally substituted alkyl group and Ar is optionally substituted aryl); (26) —SO₂NR^{E}R^{F}, where each of R^{E} and R^{F} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl group and Ar is optionally substituted aryl); and (27) —NR^{G}R^{H}, where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₈ alkynyl (e.g., optionally substituted alkyl having one or more triple bonds), (f) C₄₋₁₈ aryl, (g) (C₄₋₁₈ aryl) C₁₋₆ alkyl (e.g., L-Ar, wherein L is a bivalent form of optionally substituted alkyl group and Ar is optionally substituted aryl), (h) C₃₋₈ cycloalkyl, and (i) (C₃₋₈ cycloalkyl) C₁₋₆ alkyl (e.g., -L-Cy, wherein L is a bivalent form of optionally substituted alkyl group and Cy is optionally substituted cycloalkyl, as described herein), wherein in one embodiment no two groups are bound to the nitrogen atom through a carbonyl group or a sulfonyl group. The alkyl group can be a primary, secondary, or tertiary alkyl group substituted with one or more substituents (e.g., one or more halo or alkoxy). In some embodiments, the unsubstituted alkyl group is a C₁₋₃, C₁₋₄, C₁₋₁₂, C₁₋₁₆, C₁₋₁₈, C₁₋₂₀, or C₁₋₂₄ alkyl group.

By “alkylene” is meant a multivalent (e.g., bivalent, trivalent, tetravalent, etc.) form of an alkyl group, as described herein. Exemplary alkylene groups include methylene, ethylene, propylene, butylene, etc. In some embodiments, the alkylene group is a C₁₋₃, C₁₋₆, C₁₋₁₂, C₁₋₁₆, C₁₋₁₈, C₁₋₂₀, or C₁₋₂₄, C₂₋₃, C₂₋₆, C₂₋₁₂, C₂₋₁₆, C₂₋₁₈, C₂₋₂₀, or C₂₋₂₄ alkylene group. The alkylene group can be branched or unbranched. The alkylene group can be saturated or unsaturated (e.g., having one or more double bonds or triple bonds). The alkylene group can also be substituted or unsubstituted. For example, the alkylene group can be substituted with one or more substitution groups, as described herein for alkyl. In one instance, a substituted alkylene group can include an optionally substituted haloalkylene (e.g., an optionally substituted alkylene substituted with one or more hydroxyl groups, as defined herein), an optionally substituted haloalkylene (e.g., an optionally substituted alkylene substituted with one or more halo groups, as defined herein), and the like.

By “alkyleneoxy” is meant an alkylene group, as defined herein, attached to the parent molecular group through an oxygen atom.

By “amino” is meant —NR^{N1}R^{N2}, where each of R^{N1} and R^{N2} is, independently, H, optionally substituted alkyl, optionally substituted cycloalkyl, or optionally substituted aryl; or R^{N1} and R^{N2}, taken together with the nitrogen atom to which each are attached, form an optionally substituted heterocyclyl group or heterocycle, as defined herein; or R^{N1} and R^{N2}, taken together, form an optionally substituted alkylene or heteroalkylene (e.g., as described herein).

By “aminoalkyl” is meant an alkyl group, as defined herein, substituted by an amino group, as defined herein. Non-limiting aminoalkyl groups include -L-NR^{N1}R^{N2}, where L is a multivalent alkyl group, as defined herein; each of R^{N1} and R^{N2} is, independently, H, optionally substituted alkyl, or optionally substituted aryl; or R^{N1} and R^{N2}, taken together with the nitrogen atom to which each are attached, form a heterocyclyl group, as defined herein.

By “ammonium” is meant a group including a protonated nitrogen atom N⁺. Exemplary ammonium groups include —N⁺R^{N}R^{N2}R^{N3} where each of R^{N1}, R^{N2}, and R^{N3} is, independently, H, optionally substituted alkyl, optionally substituted cycloalkyl, or optionally substituted aryl; or R^{N1} and R^{N2}, taken together with the nitrogen atom to which each are attached, form an optionally substituted heterocyclyl group or heterocycle; or R^{N1} and R^{N2}, taken together, form an optionally substituted alkylene or heteroalkylene (e.g., as described herein); or R^{N1} and R^{N2} and R^{N3}, taken together with the nitrogen atom to which each are attached, form an optionally substituted heterocyclyl group or heterocycle, such as a heterocyclic cation.

By “aromatic” is meant a cyclic, conjugated group or moiety of, unless specified otherwise, from 5 to 15 ring atoms having a single ring (e.g., phenyl) or multiple condensed rings in which at least one ring is aromatic (e.g., naphthyl, indolyl, or pyrazolopyridinyl); that is, at least one ring, and optionally multiple condensed rings, have a continuous, delocalized π-electron system. Typically, the number of out of plane π-electrons corresponds to the Huckel rule (4n+2). The point of attachment to the parent structure typically is through an aromatic portion of the condensed ring system. Such an aromatic can be unsubstituted or substituted with one or more groups, such as groups described herein for an alkyl or aryl group. Yet other substitution groups can include aliphatic, haloaliphatic, halo, nitrate, cyano, sulfonate, sulfonyl, or others.

By “aryl” is meant a group that contains any carbon-based aromatic group including, but not limited to, phenyl, benzyl, anthracenyl, anthryl, benzocyclobutenyl, benzocyclooctenyl, biphenylyl, chrysenyl, dihydroindenyl, fluoranthenyl, indacenyl, indenyl, naphthyl, phenanthryl, phenoxybenzyl, picenyl, pyrenyl, terphenyl, and the like, including fused benzo-C₄₋₈ cycloalkyl radicals (e.g., as defined herein) such as, for instance, indanyl, tetrahydronaphthyl, fluorenyl, and the like. The term aryl also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term non-heteroaryl, which is also included in the term aryl, defines a group that contains an aromatic group that does not contain a heteroatom. The aryl group can be substituted or unsubstituted. The aryl group can be substituted with one, two, three, four, or five substituents independently selected from the group consisting of (1) C₁₋₆ alkanoyl (e.g., —C(O)-Ak, wherein Ak is optionally substituted C₁₋₆ alkyl); (2) C₁₋₆ alkyl; (3) C₁₋₆ alkoxy (e.g., —O-Ak, wherein Ak is optionally substituted C₁₋₆ alkyl); (4) C₁₋₆ alkoxy- C₁₋₆ alkyl (e.g., -L-O-Ak, wherein L is a bivalent form of optionally substituted alkyl group and Ak is optionally substituted C₁₋₆ alkyl); (5) C₁₋₆ alkylsulfinyl (e.g., —S(O)-Ak, wherein Ak is optionally substituted C₁₋₆ alkyl); (6) C₁₋₆ alkylsulfinyl- C₁₋₆ alkyl (e.g., -L-S(O)-Ak, wherein L is a bivalent form of optionally substituted alkyl group and Ak is optionally substituted C₁₋₆ alkyl); (7) C₁₋₆ alkylsulfonyl (e.g., —SO₂-Ak, wherein Ak is optionally substituted C₁₋₆ alkyl); (8) C₁₋₆ alkylsulfonyl-C₁₋₆ alkyl (e.g., -L-SO₂-Ak, wherein L is a bivalent form of optionally substituted alkyl group and Ak is optionally substituted C₁₋₆ alkyl); (9) aryl; (10) amino (e.g., —NR^{N1}R^{N2}, where each of R^{N1} and R^{N2} is, independently, H or optionally substituted alkyl, or R^{N1} and R^{N2}, taken together with the nitrogen atom to which each are attached, form a heterocyclyl group); (11) C₁₋₆ aminoalkyl (e.g., an alkyl group, as defined herein, substituted by one or more —NR^{N1}R^{N2} groups, as described herein); (12) heteroaryl (e.g., a subset of heterocyclyl groups (e.g., a 5-, 6- or 7-membered ring, unless otherwise specified, containing one, two, three, or four non-carbon heteroatoms), which are aromatic); (13) (C₄₋₁₈ aryl) C₁₋₆ alkyl (e.g., -L-Ar, wherein L is a bivalent form of optionally substituted alkyl and Ar is optionally substituted aryl); (14) aryloyl (e.g., —C(O)—Ar, wherein Ar is optionally substituted aryl); (15) azido (e.g., —N₃); (16) cyano (e.g., —CN); (17) C₁₋₆ azidoalkyl (e.g., an alkyl group, as defined herein, substituted by one or more azido groups, as described herein); (18) carboxyaldehyde (e.g., —C(O)H); (19) carboxyaldehyde- C₁₋₆ alkyl (e.g., an alkyl group, as defined herein, substituted by one or more carboxyaldehyde groups, as described herein); (20) C₃₋₈ cycloalkyl (e.g., a monovalent saturated or unsaturated non-aromatic cyclic C₃₋₈ hydrocarbon group); (21) (C₃₋₈ cycloalkyl) C₁₋₆ alkyl (e.g., an alkyl group, as defined herein, substituted by one or more cycloalkyl groups, as described herein); (22) halo (e.g., F, Cl, Br, or 1); (23) C₁₋₆ haloalkyl (e.g., an alkyl group, as defined herein, substituted by one or more halo groups, as described herein); (24) heterocyclyl (e.g., a 5-, 6- or 7-membered ring, unless otherwise specified, containing one, two, three, or four non-carbon heteroatoms, such as nitrogen, oxygen, phosphorous, sulfur, or halo); (25) heterocyclyloxy (e.g., —O-Het, wherein Het is heterocyclyl, as described herein); (26) heterocyclyloyl (e.g., —C(O)—Het, wherein Het is heterocyclyl, as described herein); (27) hydroxyl (e.g., —OH); (28) C₁₋₆ hydroxyalkyl (e.g., an alkyl group, as defined herein, substituted by one or more hydroxyl, as described herein); (29) nitro (e.g., —NO₂); (30) C₁₋₆ nitroalkyl (e.g., an alkyl group, as defined herein, substituted by one or more nitro, as described herein); (31)N-protected amino; (32) N-protected amino- C₁₋₆ alkyl (e.g., an alkyl group, as defined herein, substituted by one or more N-protected amino groups); (33) oxo (e.g., ═O) or hydroxyimino (e.g., ═N—OH); (34) C₁₋₆ thioalkoxy (e.g., —S-Ak, wherein Ak is optionally substituted C₁₋₆ alkyl); (35) thio- C₁₋₆ alkoxy-C₁₋₆ alkyl (e.g., -L-S-Ak, wherein L is a bivalent form of optionally substituted alkyl and Ak is optionally substituted C₁₋₆ alkyl); (36) —(CH₂)ᵣCO₂R^{A}, where r is an integer of from zero to four, and R^{A} is selected from the group consisting of (a) hydrogen, (b) C₁₋₆ alkyl, (c) C₄₋₁₈ aryl, and (d) (C₄₋₁₈ is aryl) C₁₋₆ alkyl (e.g., -L-Ar, wherein L is a bivalent form of optionally substituted alkyl and Ar is optionally substituted aryl); (37) —(CH₂) ᵣCONR^{B}R^{C}, where r is an integer of from zero to four and where each R^{B} and R^{C} is independently selected from the group consisting of (a) hydrogen, (b) C₁₋₆ alkyl, (c) C₄₋₁₈ aryl, and (d) (C₄₋₁₈, aryl) C₁₋₁₈ alkyl (e.g., -L-Ar, wherein L is a bivalent form of optionally substituted alkyl and Ar is optionally substituted aryl); (38) —(CH₂)ᵣSO₂R^{D}, where r is an integer of from zero to four and where R^{D} is selected from the group consisting of (a) C₁₋₆ alkyl, (b) C₄₋₁₈ aryl, and (c) (C₄₋₁₈ aryl) C₁₋₆ alkyl (e.g., -L-Ar, wherein L is a bivalent form of optionally substituted alkyl and Ar is optionally substituted aryl); (39) —(CH₂)ᵣSO₂NR^{E}R^{F}, where r is an integer of from zero to four and where each of R^{E} and R^{F} is, independently, selected from the group consisting of (a) hydrogen, (b) C₁₋₆ alkyl, (c) C₄₋₁₈ aryl, and (d) (C₄₋₁₈ aryl) C₁₋₆ alkyl (e.g., -L-Ar, wherein L is a bivalent form of optionally substituted alkyl and Ar is optionally substituted aryl); (40) —(CH₂)ᵣNR^{G}R^{H}, where r is an integer of from zero to four and where each of R^{G} and R^{H} is, independently, selected from the group consisting of (a) hydrogen, (b) an N-protecting group, (c) C₁₋₆ alkyl, (d) C₂₋₆ alkenyl (e.g., optionally substituted alkyl having one or more double bonds), (e) C₂₋₆ alkynyl (e.g., optionally substituted alkyl having one or more triple bonds), (f) C₄₋₁₈ aryl, (g) (C₄₋₁₈ aryl) C₁₋₆ alkyl (e.g., -L-Ar, wherein L is a bivalent form of optionally substituted alkyl and Ar is optionally substituted aryl), (h) C₃₋₈ cycloalkyl, and (i) (C₃₋₈ cycloalkyl) C₁₋₆ alkyl (e.g., -L-Cy, wherein L is a bivalent form of optionally substituted alkyl and Cy is optionally substituted cycloalkyl, as described herein), wherein in one embodiment no two groups are bound to the nitrogen atom through a carbonyl group or a sulfonyl group; (41) thiol (e.g., —SH); (42) perfluoroalkyl (e.g., an alkyl group having each hydrogen atom substituted with a fluorine atom); (43) perfluoroalkoxy (e.g., —OR^{F}, where R^{F} is an alkyl group having each hydrogen atom substituted with a fluorine atom); (44) aryloxy (e.g., —OAr, where Ar is optionally substituted aryl); (45) cycloalkoxy (e.g., —O-Cy, wherein Cy is optionally substituted cycloalkyl, as described herein); (46) cycloalkylalkoxy (e.g., —O-L-Cy, wherein L is a bivalent form of optionally substituted alkyl and Cy is optionally substituted cycloalkyl, as described herein); and (47) arylalkoxy (e.g., —O-L-Ar, wherein L is a bivalent form of optionally substituted alkyl and Ar is optionally substituted aryl). In particular embodiments, an unsubstituted aryl group is a C₄₋₁₈, C₄₋₁₄, C₄₋₁₂, C₄₋₁₀, C₆₋₁₈, C₆₋₁₄, C₆₋₁₂, or C₆₋₁₀ aryl group.

By “arylalkoxy” is meant an arylalkylene group, as defined herein, attached to the parent molecular group through an oxygen atom. In some embodiments, the arylalkoxy group is —O-Ak-Ar, in which Ak is an optionally substituted alkylene, as defined herein, and Ar is an optionally substituted aryl, as defined herein.

By “(aryl)(alkyl)ene” is meant a bivalent form including an arylene group, as described herein, attached to an alkylene or a heteroalkylene group, as described herein. In some embodiments, the (aryl)(alkyl)ene group is -L-Ar— or -L-Ar-L- or —Ar-L-, in which Ar is an arylene group and each L is, independently, an optionally substituted alkylene group or an optionally substituted heteroalkylene group.

By “arylalkylene” is meant an aryl group, as defined herein, attached to the parent molecular group through an alkylene group, as defined herein. In some embodiments, the arylalkylene group is -Ak-Ar, in which Ak is an optionally substituted alkylene, as defined herein, and Ar is an optionally substituted aryl, as defined herein. The arylalkylene group can be substituted or unsubstituted. For example, the arylalkylene group can be substituted with one or more substitution groups, as described herein for aryl and/or alkyl. Exemplary unsubstituted arylalkylene groups are of from 7 to 16 carbons (C₇₋₁₆ arylalkylene), as well as those having an aryl group with 4 to 18 carbons and an alkylene group with 1 to 6 carbons (i.e., (C₄₋₁₈ aryl) C₁₋₆ alkylene).

By “arylene” is meant a multivalent (e.g., bivalent, trivalent, tetravalent, etc.) form of an aryl group, as described herein. Exemplary arylene groups include phenylene, naphthylene, biphenylene, triphenylene, diphenyl ether, acenaphthenylene, anthrylene, or phenanthrylene. In some embodiments, the arylene group is a C₄₋₁₈, C₄₋₁₄, C₄₋₁₂, C₄₋₁₀, C₆₋₁₈, C₆₋₁₄, C₆₋₁₂, or C₆₋₁₀ arylene group. The arylene group can be branched or unbranched. The arylene group can also be substituted or unsubstituted. For example, the arylene group can be substituted with one or more substitution groups, as described herein for aryl.

By “aryleneoxy” is meant an arylene group, as defined herein, attached to the parent molecular group through an oxygen atom.

By “aryloxy” is meant an aryl group, as defined herein, attached to the parent molecular group through an oxygen atom.

By “aryloyl” is meant an aryl group that is attached to the parent molecular group through a carbonyl group. In some embodiments, an unsubstituted aryloyl group is a C₇₋₁₁ aryloyl or C.sub₅₋₁₉ aryloyl group. In particular embodiments, the aryloyl group is —C(O)—Ar, in which Ar is an aryl group, as defined herein.

By “boranyl” is meant a —BR₂ group, in which each R, independently, can be H, halo, or optionally substituted alkyl.

By “borono” is meant a —BOH₂ group.

By “carboxyl” is meant a —CO₂⁻ group.

By “carboxylate anion” is meant a —CO₂⁻ group.

By “covalent bond” is meant a covalent bonding interaction between two components. Non-limiting covalent bonds include a single bond, a double bond, a triple bond, or a spirocyclic bond, in which at least two molecular groups are bonded to the same carbon atom.

By “cyano” is meant a —CN group.

By “cyclic group” is used herein to refer to either aryl groups, non-aryl groups (e.g., cycloalkyl or heterocycloalkyl groups), or both. Cyclic groups have one or more ring systems that can be substituted or unsubstituted. A cyclic group can contain one or more aryl groups, one or more non-aryl groups, or one or more aryl groups and one or more non-aryl groups.

By “cycloalkyl” is meant a monovalent saturated or unsaturated non-aromatic cyclic hydrocarbon group of from three to ten carbons (e.g., C₃₋₈ or C₃₋₁₀), unless otherwise specified, and is exemplified by cyclopropyl, cyclobutyl, cyclopentyl, cyclohexyl, cycloheptyl, bicyclo[2.2.1.]heptyl, and the like. The term cycloalkyl also includes “cycloalkenyl,” which is defined as a non-aromatic carbon-based ring composed of three to ten carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like. The cycloalkyl group can also be substituted or unsubstituted. For example, the cycloalkyl group can be substituted with one or more groups including those described herein for alkyl.

By “halo” is meant F, Cl, Br, or I.

By “haloalkyl” is meant an alkyl group, as defined herein, substituted with one or more halo.

By “haloalkylene” is meant an alkylene group, as defined herein, substituted with one or more halo.

By “heteroaliphatic” is meant an aliphatic group, as defined herein, including at least one heteroatom to 20 heteroatoms, such as one to 15 heteroatoms, or one to 5 heteroatoms, which can be selected from, but not limited to oxygen, nitrogen, sulfur, silicon, boron, selenium, phosphorous, and oxidized forms thereof within the group.

By “heteroalkyl” is meant an alkyl group, as defined herein, containing one, two, three, or four non-carbon heteroatoms (e.g., independently selected from the group consisting of nitrogen, oxygen, phosphorous, sulfur, selenium, or halo).

By “heteroalkylene” is meant an alkylene group, as defined herein, containing one, two, three, or four non-carbon heteroatoms (e.g., independently selected from the group consisting of nitrogen, oxygen, phosphorous, sulfur, selenium, or halo). The heteroalkylene group can be saturated or unsaturated (e.g., having one or more double bonds or triple bonds). The heteroalkylene group can be substituted or unsubstituted. For example, the heteroalkylene group can be substituted with one or more substitution groups, as described herein for alkyl.

By“heteroaryl” is meant a subset of heterocyclyl groups, as defined herein, which are aromatic, i.e., they contain 4n+2 pi electrons within the mono- or multicyclic ring system.

The term “heterocycloalkyl” is a type of cycloalkyl group as defined above where at least one of the carbon atoms and its attached hydrogen atoms, if any, are replaced by O, S, N, or NH. The heterocycloalkyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, sulfonic acid, sulfinic acid, fluoroacid, phosphonic acid, ester, ether, halide, hydroxy, ketone, nitro, cyano, azido, silyl, sulfonyl, sulfinyl, or thiol, as described herein.

By “heterocycle” is meant a compound having one or more heterocyclyl moieties. Non-limiting heterocycles include optionally substituted imidazole, optionally substituted triazole, optionally substituted tetrazole, optionally substituted pyrazole, optionally substituted imidazoline, optionally substituted pyrazoline, optionally substituted imidazolidine, optionally substituted pyrazolidine, optionally substituted pyrrole, optionally substituted pyrroline, optionally substituted pyrrolidine, optionally substituted tetrahydrofuran, optionally substituted furan, optionally substituted thiophene, optionally substituted oxazole, optionally substituted isoxazole, optionally substituted isothiazole, optionally substituted thiazole, optionally substituted oxathiolane, optionally substituted oxadiazole, optionally substituted thiadiazole, optionally substituted sulfolane, optionally substituted succinimide, optionally substituted thiazolidinedione, optionally substituted oxazolidone, optionally substituted hydantoin, optionally substituted pyridine, optionally substituted piperidine, optionally substituted pyridazine, optionally substituted piperazine, optionally substituted pyrimidine, optionally substituted pyrazine, optionally substituted triazine, optionally substituted pyran, optionally substituted pyrylium, optionally substituted tetrahydropyran, optionally substituted dioxine, optionally substituted dioxane, optionally substituted dithiane, optionally substituted trithiane, optionally substituted thiopyran, optionally substituted thiane, optionally substituted oxazine, optionally substituted morpholine, optionally substituted thiazine, optionally substituted thiomorpholine, optionally substituted cytosine, optionally substituted thymine, optionally substituted uracil, optionally substituted thiomorpholine dioxide, optionally substituted indene, optionally substituted indoline, optionally substituted indole, optionally substituted isoindole, optionally substituted indolizine, optionally substituted indazole, optionally substituted benzimidazole, optionally substituted azaindole, optionally substituted azaindazole, optionally substituted pyrazolopyrimidine, optionally substituted purine, optionally substituted benzofuran, optionally substituted isobenzofuran, optionally substituted benzothiophene, optionally substituted benzisoxazole, optionally substituted anthranil, optionally substituted benzisothiazole, optionally substituted benzoxazole, optionally substituted benzthiazole, optionally substituted benzthiadiazole, optionally substituted adenine, optionally substituted guanine, optionally substituted tetrahydroquinoline, optionally substituted dihydroquinoline, optionally substituted dihydroisoquinoline, optionally substituted quinoline, optionally substituted isoquinoline, optionally substituted quinolizine, optionally substituted quinoxaline, optionally substituted phthalazine, optionally substituted quinazoline, optionally substituted cinnoline, optionally substituted naphthyridine, optionally substituted pyridopyrimidine, optionally substituted pyridopyrazine, optionally substituted pteridine, optionally substituted chromene, optionally substituted isochromene, optionally substituted chromenone, optionally substituted benzoxazine, optionally substituted quinolinone, optionally substituted isoquinolinone, optionally substituted carbazole, optionally substituted dibenzofuran, optionally substituted acridine, optionally substituted phenazine, optionally substituted phenoxazine, optionally substituted phenothiazine, optionally substituted phenoxathiine, optionally substituted quinuclidine, optionally substituted azaadamantane, optionally substituted dihydroazepine, optionally substituted azepine, optionally substituted diazepine, optionally substituted oxepane, optionally substituted thiepine, optionally substituted thiazepine, optionally substituted azocane, optionally substituted azocine, optionally substituted thiocane, optionally substituted azonane, optionally substituted azecine, etc. Optional substitutions include any described herein for aryl. Heterocycles can also include cations and/or salts of any of these (e.g., any described herein, such as optionally substituted piperidinium, optionally substituted pyrrolidinium, optionally substituted pyrazolium, optionally substituted imidazolium, optionally substituted pyridinium, optionally substituted quinolinium, optionally substituted isoquinolinium, optionally substituted acridinium, optionally substituted phenanthridinium, optionally substituted pyridazinium, optionally substituted pyrimidinium, optionally substituted pyrazinium, optionally substituted phenazinium, or optionally substituted morpholinium).

By “heterocyclyl” is meant a 3-, 4-, 5-, 6- or 7-membered ring (e.g., a 5-, 6-or 7-membered ring), unless otherwise specified, containing one, two, three, or four non-carbon heteroatoms (e.g., independently selected from the group consisting of nitrogen, oxygen, phosphorous, sulfur, selenium, or halo). The 3-membered ring has zero to one double bonds, the 4- and 5-membered ring has zero to two double bonds, and the 6- and 7-membered rings have zero to three double bonds. The term “heterocyclyl” also includes bicyclic, tricyclic and tetracyclic groups in which any of the above heterocyclic rings is fused to one, two, or three rings independently selected from the group consisting of an aryl ring, a cyclohexane ring, a cyclohexene ring, a cyclopentane ring, a cyclopentene ring, and another monocyclic heterocyclic ring, such as indolyl, quinolyl, isoquinolyl, tetrahydroquinolyl, benzofuryl, benzothienyl and the like. Heterocyclics include acridinyl, adenyl, alloxazinyl, azaadamantanyl, azabenzimidazolyl, azabicyclononyl, azacycloheptyl, azacyclooctyl, azacyclononyl, azahypoxanthinyl, azaindazolyl, azaindolyl, azecinyl, azepanyl, azepinyl, azetidinyl, azetyl, azirdinyl, azirinyl, azocanyl, azocinyl, azonanyl, benzimidazolyl, benzisothiazolyl, benzisoxazolyl, benzodiazepinyl, benzodiazocinyl, benzodihydrofuryl, benzodioxepinyl, benzodioxinyl, benzodioxanyl, benzodioxocinyl, benzodioxolyl, benzodithiepinyl, benzodithiinyl, benzodioxocinyl, benzofuranyl, benzophenazinyl, benzopyranonyl, benzopyranyl, benzopyrenyl, benzopyronyl, benzoquinolinyl, benzoquinolizinyl, benzothiadiazepinyl, benzothiadiazolyl, benzothiazepinyl, benzothiazocinyl, benzothiazolyl, benzothienyl, benzothiophenyl, benzothiazinonyl, benzothiazinyl, benzothiopyranyl, benzothiopyronyl, benzotriazepinyl, benzotriazinonyl, benzotrazinyl, benzotriazolyl, benzoxathiinyl, benzotrioxepinyl, benzoxadiazepinyl, benzoxathiazepinyl, benzoxathiepinyl, benzoxathiocinyl, benzoxazepinyl, benzoxazinyl, benzoxazocinyl, benzoxazolinonyl, benzoxazolinyl, benzoxazolyl, benzylsultamyl benzylsultimyl, bipyrazinyl, bipyridinyl, carbazolyl (e.g., 4H-carbazolyl), carbolinyl (e.g., (3-carbolinyl), chromanonyl, chromanyl, chromenyl, cinnolinyl, coumarinyl, cytdinyl, cytosinyl, decahydroisoquinolinyl, decahydroquinolinyl, diazabicyclooctyl, diazetyl, diaziridinethionyl, diaziridinonyl, diaziridinyl, diazirinyl, dibenzisoquinolinyl, dibenzoacridinyl, dibenzocarbazolyl, dibenzofuranyl, dibenzophenazinyl, dibenzopyranonyl, dibenzopyronyl (xanthonyl), dibenzoquinoxalinyl, dibenzothiazepinyl, dibenzothiepinyl, dibenzothiophenyl, dibenzoxepinyl, dihydroazepinyl, dihydroazetyl, dihydrofuranyl, dihydrofuryl, dihydroisoquinolinyl, dihydropyranyl, dihydropyridinyl, dihydroypyridyl, dihydroquinolinyl, dihydrothienyl, dihydroindolyl, dioxanyl, dioxazinyl, dioxindolyl, dioxiranyl, dioxenyl, dioxinyl, dioxobenzofuranyl, dioxolyl, dioxotetrahydrofuranyl, dioxothiomorpholinyl, dithianyl, dithiazolyl, dithienyl, dithiinyl, furanyl, furazanyl, furoyl, furyl, guaninyl, homopiperazinyl, homopiperdinyl, hypoxanthinyl, hydantoinyl, imidazolidinyl, imidazolinyl, imidazolyl, indazolyl (e.g., 1H-indazolyl), indolenyl, indolinyl, indolizinyl, indolyl (e.g., 1H-indolyl or 3H-indolyl), isatinyl, isatyl, isobenzofuranyl, isochromanyl, isochromenyl, isoindazoyl, isoindolinyl, isoindolyl, isopyrazolonyl, isopyrazolyl, isoxazolidiniyl, isoxazolyl, isoquinolinyl, isoquinolinyl, isothiazolidinyl, isothiazolyl, morpholinyl, naphthindazolyl, naphthindolyl, naphthiridinyl, naphthopyranyl, naphthothiazolyl, naphthothioxolyl, naphthotrazolyl, naphthoxindolyl, naphthyridinyl, octahydroisoquinolinyl, oxabicycloheptyl, oxauracil, oxadiazolyl, oxazinyl, oxaziridinyl, oxazolidinyl, oxazolidonyl, oxazolinyl, oxazolonyl, oxazolyl, oxepanyl, oxetanonyl, oxetanyl, oxetyl, oxtenayl, oxindolyl, oxiranyl, oxobenzoisothiazolyl, oxochromenyl, oxoisoquinolinyl, oxoquinolinyl, oxothiolanyl, phenanthridinyl, phenanthrolinyl, phenazinyl, phenothiazinyl, phenothienyl (benzothiofuranyl), phenoxathiinyl, phenoxazinyl, phthalazinyl, phthalazonyl, phthalidyl, phthalimidinyl, piperazinyl, piperidinyl, piperidonyl (e.g., 4-piperidonyl), pteridinyl, purinyl, pyranyl, pyrazinyl, pyrazolidinyl, pyrazolinyl, pyrazolopyrimidinyl, pyrazolyl, pyridazinyl, pyridinyl, pyridopyrazinyl, pyridopyrimidinyl, pyridyl, pyrimidinyl, pyrimidyl, pyronyl, pyrrolidinyl, pyrrolidonyl (e.g., 2-pyrrolidonyl), pyrrolinyl, pyrrolizidinyl, pyrrolyl (e.g., 2H-pyrrolyl), pyrylium, quinazolinyl, quinolinyl, quinolizinyl (e.g., 4H-quinolizinyl), quinoxalinyl, quinuclidinyl, selenazinyl, selenazolyl, selenophenyl, succinimidyl, sulfolanyl, tetrahydrofuranyl, tetrahydrofuryl, tetrahydroisoquinolinyl, tetrahydroisoquinolyl, tetrahydropyridinyl, tetrahydropyridyl (piperidyl), tetrahydropyranyl, tetrahydropyronyl, tetrahydroquinolinyl, tetrahydroquinolyl, tetrahydrothienyl, tetrahydrothiophenyl, tetrazinyl, tetrazolyl, thiadiazinyl (e.g., 6H-1,2,5-thiadiazinyl or 2H,6H-1,5,2-dithiazinyl), thiadiazolyl, thianthrenyl, thianyl, thianaphthenyl, thiazepinyl, thiazinyl, thiazolidinedionyl, thiazolidinyl, thiazolyl, thienyl, thiepanyl, thiepinyl, thietanyl, thietyl, thiiranyl, thiocanyl, thiochromanonyl, thiochromanyl, thiochromenyl, thiodiazinyl, thiodiazolyl, thioindoxyl, thiomorpholinyl, thiophenyl, thiopyranyl, thiopyronyl, thiotriazolyl, thiourazolyl, thioxanyl, thioxolyl, thymidinyl, thyminyl, triazinyl, triazolyl, trithianyl, urazinyl, urazolyl, uretidinyl, uretinyl, uricyl, uridinyl, xanthenyl, xanthinyl, xanthionyl, and the like, as well as modified forms thereof (e.g., including one or more oxo and/or amino) and salts thereof. The heterocyclyl group can be substituted or unsubstituted. For example, the heterocyclyl group can be substituted with one or more substitution groups, as described herein for aryl.

By “heterocyclyldiyl” is meant a bivalent form of a heterocyclyl group, as described herein. In one instance, the heterocyclyldiyl is formed by removing a hydrogen from a heterocyclyl group. Exemplary heterocyclyldiyl groups include piperdylidene, quinolinediyl, etc. The heterocyclyldiyl group can also be substituted or unsubstituted. For example, the heterocyclyldiyl group can be substituted with one or more substitution groups, as described herein for heterocyclyl.

By “hydroxyl” is meant an —OH group.

By “hydroxyalkyl” is meant an alkyl group, as defined herein, substituted with one or more hydroxyl.

By “hydroxyalkylene” is meant an alkylene group, as defined herein, substituted with one or more hydroxy.

By “nitro” is meant an —NO₂ group.

By “phosphate” is meant a group derived from phosphoric acid. One example of phosphate includes a —O—P(═O)(OR^{P1})(OR^{P2}) or —O—[P(═O)(OR^{P1})—O]_{P3}—R^{P2} group, where each of R^{P1} and R^{P2}, is, independently. H, optionally substituted alkyl, optionally substituted alkenyl, optionally substituted aryl, or optionally substituted arylalkylene, and where P3 is an integer from 1 to 5. Yet other examples of phosphate include orthophosphoric acid, pyrophosphoric acid, tripolyphosphoric acid, tetrapolyphosphoric acid, trimetaphosphoric acid, and/or phosphoric anhydride, or combinations thereof.

By “phosphono” or “phosphonic acid” is meant a —P(O)(OH)₂ group.

By “spirocyclyl” is meant an alkylene diradical, both ends of which are bonded to the same carbon atom of the parent group to form a spirocyclyl group and also a heteroalkylene diradical, both ends of which are bonded to the same atom. Non-limiting alkylene and heteroalkylene groups for use within a spirocyclyl group includes C₁₂, C₂₋₁₁, C₂₋₁₀, C₂₋₉, C₂₋₈, C₂₋₇, C₂₋₆, C₂₋₄, or C₂₋₃ alkylene groups, as well as C₁₋₁₂, C₁₋₁₁, C₁₋₁₀, C₁₋₉, C₁₋₈, C₁₋₇, C₁₋₆, C₁₋₅, C₁₋₄, C₁₋₃, or C₁₋₂ heteroalkylene groups having one or more heteroatoms.

By “sulfate” is meant a group derived from sulfuric acid. One example of sulfate includes a —O—S(═O)₂(OR^{S1}) group, where R^{S1} is H, optionally substituted alkyl, optionally substituted alkenyl, optionally substituted aryl, or optionally substituted arylalkylene.

By “sulfo” or“sulfonic acid” is meant an —S(O)₂OH group.

By “sulfonyl” is meant an —S(O₂— or —S(O)₂R group, in which R can be H, optionally substituted alkyl, or optionally substituted aryl. Non-limiting sulfonyl groups can include a trifluoromethylsulfonyl group (—SO₂—CF₃ or Tf).

By “thiocyanato” is meant an —SCN group.

By “salt” is meant an ionic form of a compound or structure (e.g., any formulas, compounds, or compositions described herein), which includes a cation or anion compound to form an electrically neutral compound or structure. Salts are well known in the art. For example, non-toxic salts are described in Berge S M et al., “Pharmaceutical salts,” J. Pharm. Sci. 1977 January; 66(1):1-19; and in “Handbook of Pharmaceutical Salts: Properties, Selection, and Use.” Wiley-VCH, April 2011 (2nd rev, ed., eds. P. H. Stahl and C. G. Wermuth. The salts can be prepared in situ during the final isolation and purification of the compounds of the invention or separately by reacting the free base group with a suitable organic acid (thereby producing an anionic salt) or by reacting the acid group with a suitable metal or organic salt (thereby producing a cationic salt). Representative anionic salts include acetate, adipate, alginate, ascorbate, aspartate, benzenesulfonate, benzoate, bicarbonate, bisulfate, bitartrate, borate, bromide, butyrate, camphorate, camphorsulfonate, chloride, citrate, cyclopentanepropionate, digluconate, dihydrochloride, diphosphate, dodecylsulfate, edetate, ethanesulfonate, fumarate, glucoheptonate, gluconate, glutamate, glycerophosphate, hemisulfate, heptonate, hexanoate, hydrobromide, hydrochloride, hydroiodide, hydroxyethanesulfonate, hydroxynaphthoate, iodide, lactate, lactobionate, laurate, lauryl sulfate, malate, maleate, malonate, mandelate, mesylate, methanesulfonate, methylbromide, methylnitrate, methylsulfate, mucate, 2-naphthalenesulfonate, nicotinate, nitrate, oleate, oxalate, palmitate, pamoate, pectinate, persulfate, 3-phenylpropionate, phosphate, picrate, pivalate, polygalacturonate, propionate, salicylate, stearate, subacetate, succinate, sulfate, tannate, tartrate, theophyllinate, thiocyanate, triethiodide, toluenesulfonate, undecanoate, valerate salts, and the like. Representative cationic salts include metal salts, such as alkali or alkaline earth salts, e.g., barium, calcium (e.g., calcium edetate), lithium, magnesium, potassium, sodium, and the like; other metal salts, such as aluminum, bismuth, iron, and zinc; as well as nontoxic ammonium, quaternary ammonium, and amine cations, including, but not limited to ammonium, tetramethylammonium, tetraethylammonium, methylamine, dimethylamine, trimethylamine, triethylamine, ethylamine, pyridinium, and the like. Other cationic salts include organic salts, such as chloroprocaine, choline, dibenzylethylenediamine, diethanolamine, ethylenediamine, methylglucamine, and procaine. Yet other salts include ammonium, sulfonium, sulfoxonium, phosphonium, iminium, imidazolium, benzimidazolium, amidinium, guanidinium, phosphazinium, phosphazenium, pyridinium, etc., as well as other cationic groups described herein (e.g., optionally substituted isoxazolium, optionally substituted oxazolium, optionally substituted thiazolium, optionally substituted pyrrolium, optionally substituted furanium, optionally substituted thiophenium, optionally substituted imidazolium, optionally substituted pyrazolium, optionally substituted isothiazolium, optionally substituted triazolium, optionally substituted tetrazolium, optionally substituted furazanium, optionally substituted pyridinium, optionally substituted pyrimidinium, optionally substituted pyrazinium, optionally substituted triazinium, optionally substituted tetrazinium, optionally substituted pyridazinium, optionally substituted oxazinium, optionally substituted pyrrolidinium, optionally substituted pyrazolidinium, optionally substituted imidazolinium, optionally substituted isoxazolidinium, optionally substituted oxazolidinium, optionally substituted piperazinium, optionally substituted piperidinium, optionally substituted morpholinium, optionally substituted azepanium, optionally substituted azepinium, optionally substituted indolium, optionally substituted isoindolium, optionally substituted indolizinium, optionally substituted indazolium, optionally substituted benzimidazolium, optionally substituted isoquinolinum, optionally substituted quinolizinium, optionally substituted dehydroquinolizinium, optionally substituted quinolinium, optionally substituted isoindolinium, optionally substituted benzimidazolinium, and optionally substituted purinium). Yet other salts can include an anion, such as a halide (e.g., F⁻, Cl⁻, Br⁻, or I⁻), a hydroxide (e.g., OH⁻), a borate (e.g., tetrafluoroborate (BF₄⁻), a carbonate (e.g., CO₃²⁻ or HCO₃⁻), or a sulfate (e.g., SO₄²⁻).

By “leaving group” is meant an atom (or a group of atoms) with electron withdrawing ability that can be displaced as a stable species, taking with it the bonding electrons, or an atom (or a group of atoms) that can be replaced by a substitution reaction. Examples of suitable leaving groups include H, halides, and sulfonates including, but not limited to, triflate (-OTf), mesylate (-OMs), tosylate (-OTs), brosylate (-OBs), acetate, Cl, Br, and I.

By “attaching,” “attachment,” or related word forms is meant any covalent or non-covalent bonding interaction between two components. Non-covalent bonding interactions include, without limitation, hydrogen bonding, ionic interactions, halogen bonding, electrostatic interactions, π bond interactions, hydrophobic interactions, inclusion complexes, clathration, van der Waals interactions, and combinations thereof.

### DESCRIPTION

Reference will now be made in detail to certain embodiments of the disclosed subject matter. While the disclosed subject matter will be described in conjunction with the enumerated claims, it will be understood that the exemplified subject matter is not intended to limit the claims to the disclosed subject matter.

The disclosure relates to a composition comprising a first (polymeric) structure in which at least one of these structures includes an ionizable moiety or an ionic moiety. Charge conduction through the composition can be controlled by the type and amount of charge (e.g., anionic and/or cationic charge on the first structure) provided by the ionizable/ionic moieties. The properties of the composition can be tuned based on, among other things, the groups present on the first structure. The first structure can include a polymeric unit. The polymeric unit can be a homopolymer, a copolymer, a block copolymer, or other useful combinations of repeating monomeric units.

The composition can include a plurality of first structures, in which each first structure is the same (e.g., each Ar¹, R¹, R², and rings a-c, if present, is identical in each monomeric unit). In another instance, the composition can include a plurality of first structures, in which at least two of the first structures are different (e.g., at least one of Ar¹, R¹, R², and rings a-c, if present, is different between two monomeric units). Accordingly, the composition can be a homopolymer, a copolymer, a block copolymer, or other useful combinations of repeating monomeric units.

Accordingly, the composition includes a plurality of first structures of the formula (I):

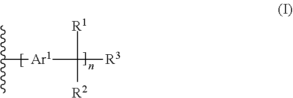

or a salt thereof, wherein:
each of R¹ and R² is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene;
at least one of R¹ and R² comprises the electron-withdrawing moiety and at least one of R¹ and R² comprises an ionizable moiety or an ionic moiety; or
R¹ and R², together with the carbon atom to which they are attached, form a cyclic group optionally substituted with an ionizable moiety or an ionic moiety;
R³ is an optionally substituted aryl group;
Ar¹ is an optionally substituted aromatic group or optionally substituted arylene; and
n is an integer of 1 or more.

Each of the first structures can be the same. Or, at least two of the first structures can be different (e.g., in which the composition includes a copolymer).

The compositions herein can include any useful combination of repeating monomeric units. In one instance, the composition can include -A-A-A- or -[A]-, in which A represent a monomeric unit and [A] represents a block including solely A monomeric units. A can be selected from those provided as a first or a second structure.

In another instance, the composition includes -[A]-[A-combination-B]—[B]—, in which A and B represents different monomeric units. [A] and [B] represent polymer blocks comprised solely of A monomeric units and solely B monomeric units, respectively. The [A-combination-B] block implies a block including some combination of A and B monomeric units. Each of A and B can be selected from those provided as a first and/or a second structure. In some embodiments, A and B are both first structures.

In another instance, the composition includes at least one alternating/periodic block, in which the different monomers have an ordered sequence, e.g., -[A-B-A-B- . . . ]-, -[A-B-C-A-B-C- . . . ]-, -[A-A-B-B-A-A-B-B- . . . ]-, -[A-A-B-A-A-B- . . . ]-, -[A-B-A-B-B-A-A-A-A-B-B-B- . . . ]-, etc. A, B, and C represent different monomeric units. The square bracketed examples represent polymer blocks, wherein the monomer sequence is repeated throughout the block.

In yet another instance, the composition includes a particular unit that is covalently bonded between at least one pair of blocks, e.g., [A]-D-[B] or [A]-D-[B]-[C], in which D can be a monomeric unit or a linking moiety (e.g., any described herein). More than one D can be present, such as in [A]-D-D-[B] or [A]-D-D-D-[B], in which each C can be the same or different. [A] represents a block comprising solely A monomeric units; [B] represents a block comprising solely B monomeric units; [C] represents a block comprising solely C monomeric units; and D can represent individual monomer units (e.g., any described herein) or linking moieties (any described herein).

Other alternative configurations are also encompassed by the compositions herein, such as branched configurations, diblock copolymers, triblock copolymers, random or statistical copolymers, stereoblock copolymers, gradient copolymers, graft copolymers, and combinations of any blocks or regions described herein

The compositions herein can be characterized by a first molecular weight (MW) of the first structure (e.g., as a polymeric unit) or a total MW of the composition. For example, the first MW or total M is a weight-average molecular weight (M_{w}) of at least 10,000 g/mol, at least 20,000 g/mol, or at least 50,000 g/mol; or from about 5,000 to 2,500,000 g/mol, such as from 10,000 to 2,500,000 g/mol, from 50,000 to 2,500,000 g/mol, from 10,000 to 250,000 g/mol, from 20,000 to 250,000 g/mol, or from 20,000 to 200,000 g/mol. The first MW or total MW can be a number average molecular weight (Mₙ) of at least 20,000 g/mol or at least 40,000 g/mol; or from about 2,000 to 2,500,000 g/mol, such as from 5,000 to 750,000 g/mol or from 10,000 to 400,000 g/mol.

The compositions can include any useful number n of monomeric units, such as 1 or more, 20 or more, 50 or more, 100 or more; as well as from 1 to 1,000,000, such as from 10 to 500, from 100 to 1,000, from 100 to 300, from 10 to 1,000,000, from 100 to 1,000,000, from 200 to 1,000,000, from 500 to 1,000,000, or from 1,000 to 1,000,000.

The compositions herein can be characterized by polydispersity index (PDI). For example, the PDI of the polymeric unit can be less than 2.7, less than 2.5, less than 2.6, less than 2.4, less than 2.3, less than 2.2, less than 2.1 or even less than 2.0 as determined by gel permeation chromatography (GPC). In other examples, the PDI of the polymeric unit can be from 1 to 3, such as from 2 to 3, 2.5 to 3,2.1 to 2.7, 2.2 to 2.6 or 2 to 2.5.

### First Structures

Within the composition, the first structure can include a polymeric unit, which in turn can include one or more ionizable or ionic moieties. In non-limiting examples, the polymeric unit can have an arylene-containing backbone, which provides an organic scaffold upon which ionizable/ionic moieties can be added.

An arylene-containing backbone can also provide an aromatic group that facilitates the addition of a reactive carbocation (e.g., by reacting with a Friedel-Crafts alkylation reagent). In this way, monomeric units having aromatic groups can be reacted together to form a polymeric unit. Such addition/polymerization reactions can be promoted in any useful manner, e.g., by including an electron-withdrawing group in proximity to that carbocation. Thus, in some non-limiting instances, the first structure can include both optionally substituted aromatic groups and electron-withdrawing groups.

The reactive carbocation can also provide functional groups that can be further modified. For instance, the reactive carbocation can be attached to a -L^{A}-RG group, in which L^{A} is a linking moiety (e.g., any herein) and RG is a reactive group (e.g., halo). After adding the carbocation and -L^{A}-RG group to the polymeric unit, the RG group can be further reacted with an ionizable reagent (e.g., such as an amine, NR^{N1}R^{N2}R³) to provide an ionic moiety (e.g., such as an ammonium, —N⁺R^{N1}R^{N2}R^{N3}).

Accordingly, the first structure can include a polymeric unit (e.g., any described herein) having an ionizable/ionic moiety and an electron-withdrawing group. In some instances, the polymeric unit is formed by using one or more monomeric units. Non-limiting monomeric units can include one or more of the following:

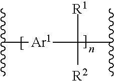

or a salt thereof, wherein:
each of R¹ and R² is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene;
at least one of R¹ and R² comprises the electron-withdrawing moiety and at least one of R¹ and R² comprises an ionizable moiety or an ionic moiety; or
R¹ and R², together with the carbon atom to which they are attached, form a cyclic group optionally substituted with an ionizable moiety or an ionic moiety;
Ar¹ is an optionally substituted aromatic group or optionally substituted arylene; and
n is an integer of 1 or more.

Non-limiting examples of Ar¹ include, e.g., phenylene (e.g., 1,4-phenylene, 1,3-phenylene, etc.), biphenylene (e.g., 4,4′-biphenylene, 3,3′-biphenylene, 3,4′-biphenylene, etc.), terphenylene (e.g., 4,4′-terphenylene), triphenylene, diphenyl ether, anthracene (e.g., 9,10-anthracene), naphthalene (e.g., 1,5-naphthalene, 1,4-naphthalene, 2,6-naphthalene, 2,7-naphthalene, etc.), tetrafluorophenylene (e.g., 1,4-tetrafluorophenylene, 1,3-tetrafluorophenylene), and the like, as well as others described herein.

Thus, for example, Ar¹ can be:

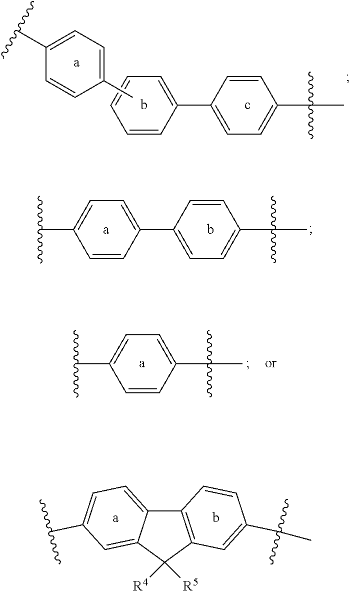

wherein:
each of R⁴ and R⁵ can, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or R⁴ and R⁵, together with the carbon atom to which they are attached, form an optionally substituted cyclic group;
each of ring a, ring b, and/or ring c can be optionally substituted; and
one or more of rings a-c optionally comprises an ionizable moiety or an ionic moiety.

Ar¹ can be, for example:

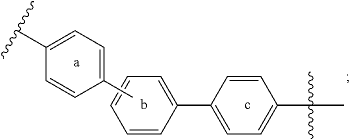

such as:

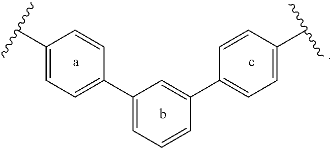 [SMILES: *c1ccc(-c2cccc(-c3ccc(*)cc3)c2)cc1]

Accordingly, the monomeric units can include one or more of the following:

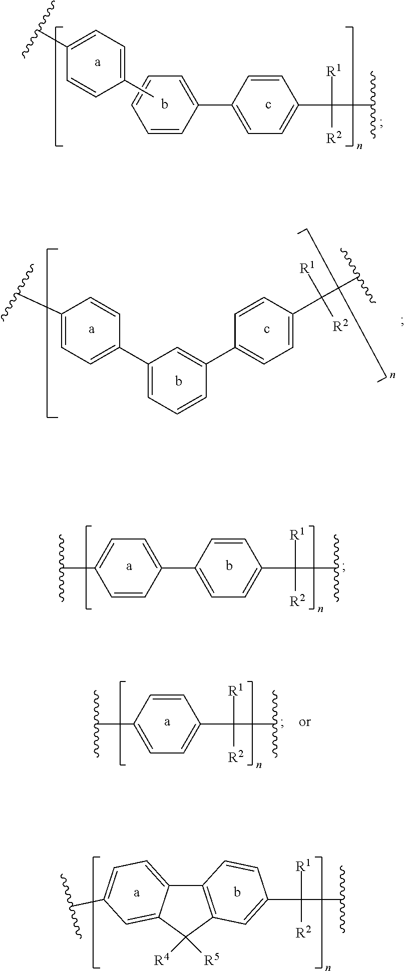

(and combinations thereof); such that the first structures of the formula (I) can be:

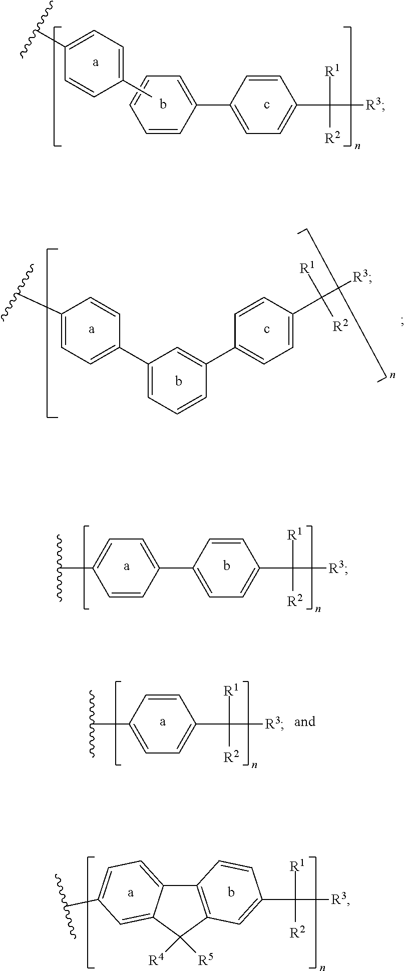

respectively.

Further substitutions for ring a, ring b, ring c, R¹, and R² can include one or more optionally substituted arylene, as well as any described herein for alkyl or aryl.

Ring a, ring b, and/or ring c includes an ionizable moiety or an ionic moiety. In other embodiments, R² includes an ionizable moiety or an ionic moiety. In particular embodiments, the ionic moiety includes or is -L^{A}-X^{A}, in which L^{A} is a linking moiety (e.g., optionally substituted aliphatic, alkylene, heteroaliphatic, heteroalkylene, aromatic, or arylene); and X^{A} is an acidic moiety, a basic moiety, a multi-ionic moiety, a cationic moiety, or an anionic moiety. Non-limiting examples of X^{A} include amino, ammonium cation, heterocyclic cation, piperidinium cation, azepanium cation, phosphonium cation, phosphazenium cation, or others herein.

In other embodiments, R¹ includes the electron-withdrawing moiety. Non-limiting electron-withdrawing moieties can include or be an optionally substituted haloalkyl (e.g., C₁₋₆ haloalkyl, including halomethyl, perhalomethyl, haloethyl, perhaloethyl, and the like), cyano (CN), phosphate (e.g., —O(P═O)(OR^{P1})(OR^{P2}) or —O—[P(═O)(OR^{P1})—O]_{P3}—R^{P2}), sulfate (e.g., —O—S(═O)₂(OR^{S1})), sulfonic acid (—SO₃H), sulfonyl (e.g., —SO₂—CF₃), difluoroboranyl (—BF₂), borono (—B(OH)₂), thiocyanato (—SCN), or piperidinium. In further embodiments, R¹ includes the electron-withdrawing moiety, and R² includes the ionizable/ionic moiety. Yet other non-limiting phosphate groups can include derivatives of phosphoric acid, such as orthophosphoric acid, pyrophosphoric acid, tripolyphosphoric acid, tetrapolyphosphoric acid, trimetaphosphoric acid, and/or phosphoric anhydride, or combinations thereof.

Non-limiting haloalkyl groups include fluoroalkyl (e.g., —CₓF_{y}H_{z}), perfluoroalkyl (e.g., —CₓF_{y}), chloroalkyl (e.g., —CₓCl_{y}H_{z}), perchloroalkyl (e.g., —CₓCl_{y}), bromoalkyl (e.g., —CₓBr_{y}H_{z}), perbromoalkyl (e.g., —CₓBr_{y}), iodoalkyl (e.g., —CₓI_{y}H_{z}), or periodoalkyl (e.g., —CₓI_{y}). In some embodiments, x is from 1 to 6, y is from 1 to 13, and z is from 0 to 12. In particular embodiments, z=2x+1−y. In other embodiments, x is from 1 to 6, y is from 3 to 13, and z is 0 (e.g., and y=2x+1).

In any of the foregoing non-limiting polymeric units, an R², R⁴ or R⁵ can be a group of the formula -L^{A}-X^{A} or -L^{A}-(X^{A}′)₂, wherein each L^{A} is, independently, a linking moiety; and each X^{A} or X^{A}′ is, independently, an acidic moiety or a basic moiety.

The polymeric unit can include one or more substitutions to a ring portion of the unit (e.g., as provided by an aromatic or arylene group) or to a linear portion (e.g., as provided by an aliphatic or alkylene group). Non-limiting substitutions can include lower unsubstituted alkyl (e.g., C₁₋₆ alkyl), lower substituted alkyl (e.g., optionally substituted C₁₋₆ alkyl), lower haloalkyl (e.g., C₁₋₆ haloalkyl), halo (e.g., F, Cl, Br, or I), unsubstituted aryl (e.g., phenyl), halo-substituted aryl (e.g., 4-fluoro-phenyl), substituted aryl (e.g., substituted phenyl), and others.

As described herein, R¹ and R² and R⁴ and R⁵, together with the carbon atom to which they are attached, can form a cyclic group, which can be optionally substituted. For instance, R¹ and R² can be taken together to form an optionally substituted spirocyclyl group, as defined herein. The spirocyclyl group can be substituted, independently, with one or more ionizable moieties or ionic moieties (e.g., any described herein). Examples where R¹ and R² and R⁴ and R⁵ form a spirocyclic group include:

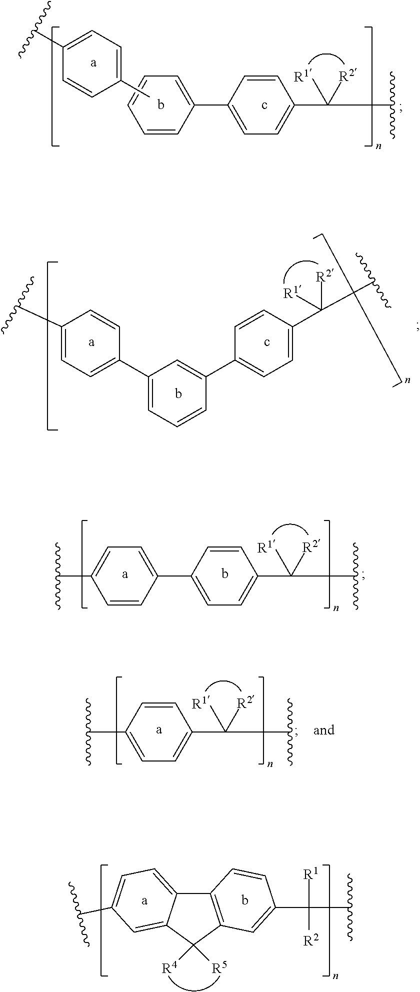

or a salt thereof, wherein R¹′ and R² and R⁴′ and R⁵′ are taken together to form an optionally substituted alkylene group or an optionally substituted heteroalkylene group. The optionally substituted alkylene group or the optionally substituted heteroalkylene group can be substituted, independently, with one or more ionizable moieties or ionic moieties.

### Further Polymeric Units

The compositions and first structure(s) described herein can include two or more polymeric units, which are attached directly or indirectly (e.g., by way of a linking moiety) to each other. See, e.g., Published U.S. Appl. No. 2022/0119641, which is incorporated by reference as if fully set forth herein (e.g., the “second structures” described therein). The polymeric unit can be a homopolymer, a copolymer, a block copolymer, a polymeric blend, or other useful combinations of repeating monomeric units. The following provides further monomeric and polymeric units that can be employed.

Monomeric units can include an optionally substituted aliphatic group, an optionally substituted aromatic group, and combinations thereof. Non-limiting monomeric units can include optionally substituted arylene, optionally substituted aryleneoxy, optionally substituted alkylene, or combinations thereof, such as optionally substituted (aryl) (alkyl)ene (e.g., -Ak-Ar— or -Ak-Ar-Ak- or —Ar-Ak-, in which Ar is an optionally substituted arylene and Ak is an optionally substituted alkylene).

Yet other monomeric units can include:

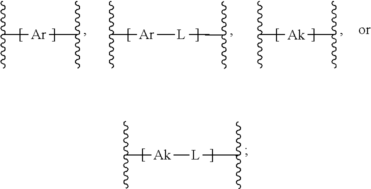

in which Ar is an optionally substituted arylene or optionally substituted aromatic; Ak is an optionally substituted alkylene or optionally substituted haloalkylene, optionally substituted heteroalkylene, optionally substituted aliphatic, or optionally substituted heteroaliphatic; and L is a linking moiety (e.g., any described herein) or can be —C(R¹)(R²)—. One or more monomeric units can be optionally substituted with one or more ionizable or ionic moieties (e.g., as described herein). In particular embodiments, at least one monomeric unit is substituted with one or more ionizable or ionic moieties.

One or more monomeric units can be combined to form a polymeric unit. Non-limiting polymeric units include any of the following:

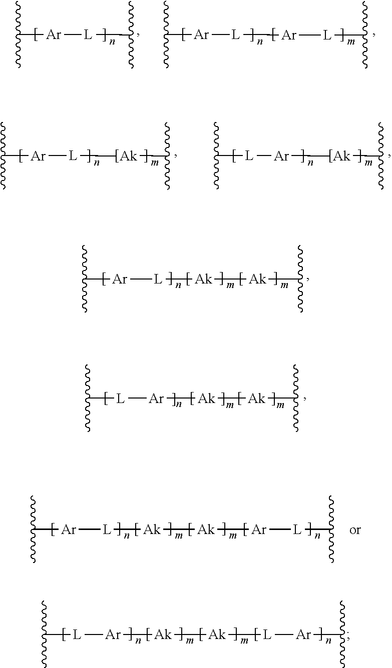

wherein Ar is an optionally substituted arylene or an optionally substituted aromatic, Ak is an optionally substituted alkylene or optionally substituted aliphatic, L is a linking moiety (e.g., any described herein), each n is independently an integer of 1 or more, and each m is independently 0 or an integer of 1 or more. Any number and type of monomeric units can be combined to form the polymeric unit.

In particular embodiments, the polymeric unit includes more than one arylene group. For instance, in a polymeric unit having this structure:

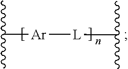

wherein n can be greater than 1 and/or Ar can include two or more aromatic or arylene groups. The presence of such aromatic groups may be used to build linear chains within the composition.

In other embodiments, L is an optionally substituted C₁₋₆ aliphatic, optionally substituted C₁₋₆ alkylene, optionally substituted C₁₋₆ heteroalkylene. The use of short linkers could provide more extensive polymeric networks, as shorter linkers could minimize self-cyclization reactions.

The polymeric unit can include one or more substitutions to a ring portion of the unit (e.g., as provided by an aromatic or arylene group) or to a linear portion (e.g., as provided by an aliphatic or alkylene group). Non-limiting substitutions can include lower unsubstituted alkyl (e.g., C₁₋₆ alkyl), lower substituted alkyl (e.g., optionally substituted C₁₋₆ alkyl), lower haloalkyl (e.g., C₁₋₆ haloalkyl), halo (e.g., F, Cl, Br, or I), unsubstituted aryl (e.g., phenyl), halo-substituted aryl (e.g., 4-fluoro-phenyl), substituted aryl (e.g., substituted phenyl), and others.

In some embodiments of the polymeric unit, L is a covalent bond, —O—, —NR^{N1}—, —C(O)—, —SO₂—, optionally substituted alkylene (e.g., —CH₂— or —C(CH₃)₂—), optionally substituted alkyleneoxy, optionally substituted haloalkylene (e.g., —CF₂— or —C(CF₃)₂—), optionally substituted heteroalkylene, optionally substituted arylene, optionally substituted aryleneoxy, optionally substituted heterocyclyldiyl, —SO—NR^{N1}-Ak-, —(O-Ak)_{L1}-SO₂—NR^{N1}-Ak-, -Ak-, -Ak-(O-Ak)_{L1}-, —(O-Ak)_{L1}-, -(Ak-O)_{L1}—, —C(O)O-Ak-, —Ar—, or —Ar—O—, as well as combinations thereof. In particular embodiments, Ak is an optionally substituted alkylene or optionally substituted haloalkylene; R^{N1} is H or optionally substituted alkyl or optionally substituted aryl; Ar is an optionally substituted arylene; and L1 is an integer from 1 to 3.

In one instance, a polymeric subunit can lack ionic moieties. Alternatively, the polymeric subunit can include an ionic moiety on the Ar group, the L group, both the Ar and L groups, or be integrated as part of the L group. Non-limiting examples of ionizable and ionic moieties including cationic, anionic, and multi-ionic group, as described herein.

Yet other polymeric units can include poly(benzimidazole) (PBI), polyphenylene (PP), polyimide (PI), poly(ethyleneimine) (PEI), sulfonated polyimide (SPI), polysulfone (PSF), sulfonated polysulfone (SPSF), poly(ether ether ketone) (PEEK), PEEK with cardo groups (PEEK-WC), polyethersulfone (PES), sulfonated polyethersulfone (SPES), sulfonated poly(ether ether ketone) (SPEEK), SPEEK with cardo groups (SPEEK-WC), poly(p-phenylene oxide) (PPO), sulfonated polyphenylene oxide (SPPO), ethylene tetrafluoroethylene (ETFE), polytetrafluoroethylene (PTFE), poly(epichlorohydrin) (PECH), poly(styrene) (PS), sulfonated poly(styrene) (SPS), hydrogenated poly(butadiene-styrene) (HPBS), styrene divinyl benzene copolymer (SDVB), styrene-ethylene-butylene-styrene (SEBS), sulfonated bisphenol-A-polysulfone (SPSU), poly(4-phenoxy benzoyl-1,4-phenylene) (PPBP), sulfonated poly(4-phenoxy benzoyl-1.4-phenylene) (SPPBP), poly(vinyl alcohol) (PVA), poly(phosphazene), poly(aryloxyphosphazene), polyetherimide, as well as combinations thereof.

### Ionizable and Ionic Moieties

The compositions herein can include one or more ionizable or ionic moieties.

Such moieties can include an anionic or cationic charge, such as in an ionic moiety. Alternatively, an ionizable moiety includes a functional group that can be readily converted into an ionic moiety, such as an ionizable moiety of a carboxy group (—CO₂H) that can be readily deprotonated to form a carboxylate anion (—CO₂—). As used herein, the terms “ionizable” and “ionic” are used interchangeably.

Ionizable or ionic moieties can be provided in the composition in any useful way. In one embodiment, the first structure includes one or more ionizable/ionic moieties.

Moieties can be characterized as an acidic moiety (e.g., a moiety can be deprotonated or can carry a negative charge) or a basic moiety (e.g., a moiety that can be protonated or carry a positive charge). In particular embodiments, the moiety can be a multi-ionic moiety, which can include a plurality of acidic moieties, a plurality of basic moieties, or a combination thereof (e.g., such as in a zwitterionic moiety). Further moieties can include a zwitterionic moiety, such as those including an anionic moiety (e.g., hydroxyl or a deprotonated hydroxyl) and a cationic moiety (e.g., ammonium).

The ionic moieties herein can be connected to the parent structure by way of one or more linking moieties. Furthermore, a single ionic moiety can be extended from a single linking moiety, or a plurality of ionic moieties can have one or more linking moieties therebetween.

For instance, the ionic moiety can have any of the following structures: -L^{A}-X^{A} or -L^{A}(L^{A}′-X^{A})₂ or -L^{A}-(X^{A}-L^{A}′-X)₂ or -L^{A}-X^{A}-L^{A}′-X^{A}′-L^{A}″-X^{A}″, in which each L^{A}, L^{A}′, and L^{A}″ is a linking moiety; each X^{A}, X^{A}′, and X^{A}″ includes, independently, an acidic moiety, a basic moiety, or a multi-ionic moiety; and L2 is an integer of 1, 2, 3, or more (e.g., from 1 to 20).

Non-limiting linking moieties (e.g., for L^{A}, L^{A}′, and L^{A}″) include a covalent bond, a spirocyclic bond, —O—, —NR^{N1}—, —SO₂—NR^{N1}-Ak-, —(O-Ak)_{L1}-SO₂—NR^{N1}-Ak-, -Ak-, -Ak-(O-Ak)_{L1}-, —(O-Ak)_{L1}-, -(Ak-O)_{L1}—, —C(O)O-Ak-, —Ar—, or —Ar—O, in which Ak is an optionally substituted alkylene or optionally substituted haloalkylene, R^{N1} is H or optionally substituted alkyl, Ar is an optionally substituted arylene, and L1 is an integer from 1 to 3. In particular embodiments, L^{A} is —(CH₂)_{L1}—, —O(CH₂)_{L1}—, —(CF₂)_{L1}—, —O(CF₂)_{L1}—, or —S(CF₂)_{L1}—, in which L1 is an integer from 1 to 3.

In some instances, a linker is attached to two or more ionic moieties. In some embodiments, the ionic moiety can be -L^{A}-(L^{A}′-X^{A})₂, in which L^{A} and L^{A}′ are linking moieties and X^{A} is an acidic moiety, a basic moiety, or a multi-ionic moiety. In one instance, L^{A} provides one, two, or three linkages. Non-limiting L^{A} can be —CX₂(CX₂—), —CX(CX₂—)₂, or —C(CX₂—)₃, in which X is H, alkyl, or halo. L^{A}′ can then provide an attachment point to the ionic moiety. For instance, L^{A}1′ can be —(CH₂)_{L1}—, —O(CH₂)_{L1}—, —(CF₂)_{L1}—, —O(CF₂)_{L1}—, or —S(CF₂)_{L1}—, in which L1 is an integer from 1 to 3; and X^{A} is any ionizable or ionic moiety described herein. For example, each L^{A} can be optionally substituted alkylene, such as optionally substituted C₁₋₁₀ alkyl (e.g., C₂₋₆ alkyl, such as ethyl, propyl, butyl, pentyl, and hexyl).

Non-limiting ionic moieties include carboxy (—CO₂H), carboxylate anion (—CO₂—), a guanidinium cation (e.g., —NR^{N1}—C(═NR^{N2}R^{N3})(N^{R4}R^{N5}) or >N═C(NR^{N2}R^{N3}) (NR^{N4}R^{N5})), or a salt form thereof. Non-limiting examples of each of R^{N1}, R^{N2}, R^{N3}, R^{N4}, and R^{N5} is, independently, H, optionally substituted alkyl, optionally substituted aryl, or optionally substituted amino; or R^{N1} and R^{N2}, R^{N2} and R^{N3}, R^{N3} and R^{N4}, R^{N1} and R^{N2}, or R^{N1} and R^{N4} taken together with the nitrogen atom to which each are attached, form an optionally substituted heterocyclyl, heterocycle, or heterocyclic cation, as defined herein.

Some ionic moieties can include one or more sulfur atoms. Non-limiting sulfur-containing moieties include sulfo (—SO₂OH), sulfonate anion (—SO₂O—), sulfonium cation (e.g., —SR^{S1}R^{S2}), sulfate (e.g., —O—S(═O)₂(OR^{S1})), sulfate anion (—O—S(═O)₂O—), or a salt form thereof. Non-limiting examples of each of R^{S1} and R^{S2}is, independently, H, optionally substituted alkyl, optionally substituted aryl, or optionally substituted amino; or R^{S1} and R^{S2} taken together with the sulfur atom to which each are attached, form an optionally substituted heterocyclyl, heterocycle, or heterocyclic cation, as defined herein; or R^{S1} and R^{S2}, taken together, form an optionally substituted alkylene or heteroalkylene (e.g., as described herein).

Other ionic moieties can include one or more phosphorous atoms. Non-limiting phosphorous-containing moieties include phosphono (e.g., —P(═O)(OH)₂), phosphonate anion (e.g., —P(═O)(O⁻)₂ or —P(═O)(OH)(O⁻)), phosphate (e.g., —O—P(═O)(OR^{P1})(OR^{P2}) or —O—[P(═O)(OR^{P1})—O]_{P3}—R^{P2}), phosphate anion (e.g., —O—P(═O)(OR^{P1})(O⁻) or —O—P(═O)(O⁻)₂), phosphonium cation (e.g., —P⁺R^{P1}R^{P2}R^{P3}), phosphazenium cation (e.g., —P⁺(═NR^{N1}R^{N2})R^{P1}R^{P2}, in which each of R^{N1} and R^{N2} is, independently, optionally substituted alkyl or optionally substituted aryl), or a salt form thereof. Non-limiting examples of each of R^{P1}, R^{P2}, and R^{P3} is, independently, H, optionally substituted alkyl, optionally substituted aryl, or optionally substituted amino; or R^{P1} and R^{P2}, taken together with the phosphorous atom to which each are attached, form an optionally substituted heterocyclyl, heterocycle, or heterocyclic cation, as defined herein; or R^{P1} and R^{P2} and R^{P3}, taken together with the phosphorous atom to which each are attached, form an optionally substituted heterocyclyl, heterocycle, or heterocyclic cation, as defined herein; or a single, double, or non-localized pi bond, provided that a combination of bonds result in a tetravalent phosphorous; or wherein two of R^{P1}, R^{P2}, and R^{P3}, taken together, form an optionally substituted alkylene or heteroalkylene (e.g., as described herein).

Yet other ionic moieties can include one or more nitrogen atoms. Non-limiting nitrogen-containing moieties include amino (e.g., —NR^{N1}R^{N2}), ammonium cation (e.g., —N⁺R^{N1}R^{N2}R^{N3} or —N⁺R^{N1}R^{N2}—), heterocyclic cation (e.g., piperidinium, 1,1-dialkyl-piperidinium, pyrrolidinium, 1,1-dialkyl-pyrrolidinium, pyridinium, 1-alkylpyridinum, (1,4-diazabicyclo[2.2.2]octan-1-yl) (DABCO), 4-alkyl-(1,4-diazabicyclo[2.2.2]octan-1-yl), etc.), or a salt form thereof. Non-limiting examples of each of R^{N1}, R^{N2}, and R^{N3} is, independently, H, optionally substituted alkyl, optionally substituted cycloalkyl, or optionally substituted aryl; or R^{N1} and R^{N2}, taken together with the nitrogen atom to which each are attached, form an optionally substituted heterocyclyl, heterocycle, or heterocyclic cation, as defined herein; or R^{N1} and R^{N2} and R^{N3}, taken together with the nitrogen atom to which each are attached, form an optionally substituted heterocyclyl, heterocycle, or heterocyclic cation, as defined herein; or wherein two of R^{N1}, R^{N2}, and R^{N3}, taken together, form an optionally substituted alkylene or heteroalkylene (e.g., as described herein); or a single, double, or non-localized pi bond, provided that a combination of bonds result in a tetravalent nitrogen.

Yet other heterocyclic cations include piperidinium cations, such as dimethyl piperidinium, methyl piperidinium (e.g., 1-methyl-piperidinium-1-yl), ethylmethyl piperidinium, ethyl piperidinium (e.g., 1-ethyl-piperidinium-1-yl), propylmethyl piperidinium, propyl piperidinium (e.g., 1-propyl-piperidinium-1-yl), butylmethyl piperidinium, butyl piperidinium (e.g., 1-butyl-piperidinium-1-yl), diethyl piperidinium, propylethyl piperidinium, butylethyl piperidinium, butylpropyl piperidinium, or spiro-1,1′-bipiperidinium; pyrrolidinium cations, such as dimethyl pyrrolidinium, ethylmethyl pyrrolidinium, propylmethyl pyrrolidinium, butylmethyl pyrrolidinium, diethyl pyrrolidinium, propylethyl pyrrolidinium, butylethyl pyrrolidinium, butylpropyl pyrrolidinium, spiro-1,1′-bipyrrolidinium, spiro-1-pyrrolidinium-1′-piperidinium, or spiro-1-pyrrolidinium-1′-morpholinium; pyrazolium cations, such as dimethyl pyrazolium, ethylmethyl pyrazolium, or butylmethyl pyrazolium; imidazolium cations, such as 3-alkyl imidazolium, 1,2-dialkylimidazolium, such as 1,2-dimethyl-1H-imidazol-3-ium; those having one nitrogen and five or six carbon ring members, such as pyridinium, 2-methylpyridinium, 3-methylpyridinium, 4-methylpyridinium, 2,6-dimethylpyridinium, quinolinium, isoquinolinium, acridinium, or phenanthridinium; those having two nitrogen and four carbon ring members, such as pyridazinium, pyrimidinium, pyrazinium or phenazinium; or those having one nitrogen and one oxygen ring member, such as morpholinium, 2-methyl morpholinium, or 3-methyl morpholinium.

Any of the heterocyclic cations can be attached to the polymer either directly or indirectly (e.g., by way of a linker or a linking moiety). Furthermore, any atom within the heterocyclic cation (e.g., within the ring of the heterocyclic cation) can be attached to the polymer. For instance, taking piperidinium as the non-limiting heterocyclic cation, such a cation can be attached to the polymer by way of the cationic center or by way of an atom within the ring, and such attachments can be direct by way of a covalent bond or indirect by way of L^{A} (a linking moiety, such as any described herein):

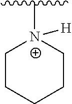 [SMILES: *[NH+]1CCCCC1]

(piperidin-1-ium-1-yl),

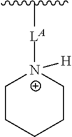

piperidin-1-ium-1-yl attached by way of L^{A}),

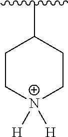 [SMILES: *C1CC[NH2+]CC1]

(piperidin-1-ium-4-yl), or

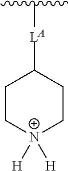

(piperidin-1-ium-4-yl attached by way of L^{A}). In addition to attachment at the 1- or 4-position of piperidin-1-ium, other attachment sites can be implemented at any point on the ring.

In some embodiments, the heterocyclic cations is or comprises a piperidinium cation or an azepanium cation. In one embodiments, the heterocyclic cation includes the following structure:

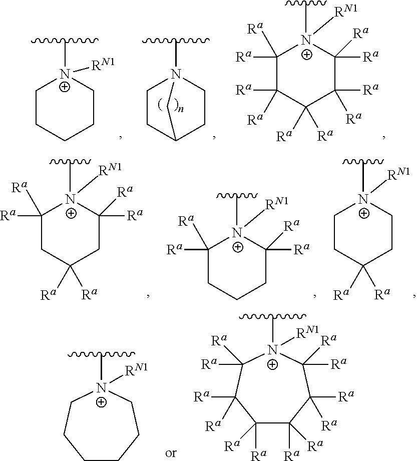

wherein:
R^{N1} is H, optionally substituted aliphatic, optionally substituted alkyl, optionally substituted heteroaliphatic, optionally substituted heteroalkyl, optionally substituted aromatic, or optionally substituted aryl;
n is 1, 2, 3, 4, or 5; and
each R^{a} is, independently, H, optionally substituted aliphatic, optionally substituted alkyl, optionally substituted heteroaliphatic, optionally substituted heteroalkyl, optionally substituted aromatic, optionally substituted aryl, an ionizable moiety, or an ionic moiety;
wherein R^{N1} and at least one R^{a} can be taken together to form an optionally substituted cyclic group or an optionally substituted heterocyclic group, and/or wherein at least two R^{a} groups can be taken together to form an optionally substituted cyclic group or an optionally substituted heterocyclic group.

In one instance. R^{N1} and R^{a} can be taken together to form an optionally substituted alkylene group or an optionally substituted heteroalkylene group. In particular embodiments, the alkylene or heteroalkylene group is substituted, independently, with one or more ionizable moieties or ionic moieties (e.g., any described herein).

In another instance, at least one R^{a} is optionally substituted aliphatic or optionally substituted alkyl. Non-limiting examples of R^{a} include methyl, ethyl, n-propyl, isopropyl, n-butyl, sec-butyl, isobutyl, tert-butyl, n-pentyl, sec-pentyl, isopentyl, tert-pentyl, neopentyl, 3-pentyl, sec-isopentyl, and the like. In other embodiments, the heterocyclic cation has a ring having one, two, three, four, five, or six R^{a} groups that is not H. In yet other embodiments, the heterocyclic cation has a ring having one, two, three, four, five, or six R^{a} groups that is, independently, optionally substituted aliphatic or optionally substituted alkyl. Without wishing to be limited by mechanism, the presence of bulky substituents may provide more stable cations. In other embodiments, any ionizable moiety or ionic moiety herein can be substituted with one or more R^{a} groups.

Yet other non-limiting piperidinium cations or azepanium cations include any of the following:

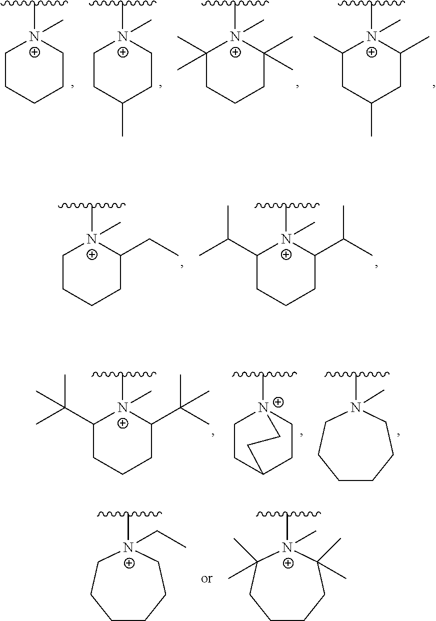

and the like.

Other moieties can include -L^{A}-L^{A}′-X^{A}, in which L^{A} is or includes optionally substituted aromatic, optionally substituted arylene, optionally substituted heterocycle, or optionally substituted heterocyclyl (e.g., optionally substituted phenylene or optionally substituted aryleneoxy); L^{A}′ is or includes optionally substituted aliphatic, optionally substituted alkylene, optionally substituted heteroaliphatic, or optionally substituted heteroalkylene (e.g., optionally substituted C₁₋₆ alkylene or optionally substituted C₁₋₆ heteroalkylene); and X^{A} is or includes an ionic moiety including one or more nitrogen atoms. Non-limiting ionic moieties include pyridinium (e.g., pyridinum-1-yl, Pyrd; alkylpyridinium, such as 2-methylpyridinum-1-yl, 2MPyrd; or aromatic pyrdinium, such as 1-benzylpyridinium-4-yl), imidazolium (e.g., 1,2-dialkylimidazolium-3-yl, including 1,2-dimethylimidazolium-3-yl (1,2-DMim)), 4-aza-1-azoniabicyclo[2.2.2]octan-1-yl (or 1,4-diazabicyclo[2.2.2]octane (DABCO) cation), 4-alkyl-1,4-diazoniabicyclo[2.2.2]octan-1-yl (e.g., 4-methyl-1,4-diazoniabicyclo[2.2.2]octan-1-yl (MAABCO) cation), 4-benzyl-1,4-diazoniabicyclo[2.2.2]octan-1-yl (or 1-benzyl-1,4-diazoniabicyclo[2.2.2] octane (BABCO) cation), aliphatic ammonium (e.g., hexyldimethylammonium-1-yl (DMHA), dicyclohexylmethylammonium-1-yl (MCH), methyldi-n-propylammonium-1-yl (MnPr), trmethylammonium-1-yl (TMA), or triethylammonium-1-yl (TEA)), aromatic ammonium (e.g., dialkylbenzylammonium, such as benzyldimethylammonium-1-yl, benzyldiethylammonium-1-yl, benzylhexylmethylammonium-1-yl, benzyldi-n-propylammonium-1-yl, benzylmethyl-n-propylammonium-1-yl, benzyldicyclohexylammonium-1-yl, benzylcyclohexylmethylammonium-1-yl, (3-nitrobenzyl)dimethylammonium-1-yl, or (3-methoxybenzyl)dimethylammonium-1-yl; or dialkyl(phenylalkyl)ammonium, such as dimethyl(phenylhexyl)ammonium-1-yl), and piperidinium (e.g., aliphatic piperidinium, such as 1-methyl-piperidinium-1-yl (Mepip), 1,2-dialkyl-piperdinium, or 1,2-dimethyl-piperidinium-4-yl (DMP); or aromatic piperidinium, such as or 1-benzyl-1-methyl-piperidinium-4-yl (BMP), as well as any piperidinium cation described herein).

Yet other moieties can include -L^{A}-X^{A}, in which L^{A} is a covalent bond (including a spirocyclic bond), optionally substituted aliphatic, optionally substituted alkylene, optionally substituted heteroaliphatic, optionally substituted heteroalkylene, optionally substituted aromatic, optionally substituted arylene, optionally substituted heterocycle, or optionally substituted heterocyclyl (e.g., optionally substituted C₁₋₆ alkylene, optionally substituted C₁₋₆ heteroalkylene, optionally substituted phenylene, or optionally substituted aryleneoxy); and X^{A} is or includes an ionic moiety including one or more nitrogen atoms. Non-limiting ionic moieties include pyridinium (e.g., pyridinum-1-yl, Pyrd; alkylpyridinium, such as 2-methylpyridinum-1-yl, 2MPyrd; or aromatic pyridinium, such as 1-benzylpyrdinium-4-y), imidazolium (e.g., 1,2-dialkylimidazolium-3-yl, including 1,2-dimethylimidazolium-3-yl (1,2-DMim)), 4-aza-1-azoniabicyclo[2.2.2]octan-1-yl (or 1,4-diazabicyclo[2.2.2]octane (DABCO) cation), 4-alkyl-1,4-diazoniabicyclo[2.2.2]octan-1-yl (e.g., 4-methyl-1,4-diazoniabicyclo[2.2.2]octan-1-yl (MAABCO) cation), 4-benzyl-1,4-diazoniabicyclo[2.2.2]octan-1-yl (or 1-benzyl-1,4-diazoniabicyclo[2.2.2] octane (BABCO) cation), aliphatic ammonium (e.g., hexyldimethylammonium-1-yl (DMHA), dicyclohexylmethylammonium-1-yl (MCH), methyldi-n-propylammonium-1-yl (MnPr), trmethylammonium-1-yl (TMA), or triethylammonium-1-yl (TEA)), aromatic ammonium (e.g., dialkylbenzylammonium, such as benzyldimethylammonium-1-yl, benzyldiethylammonium-1-yl, benzylhexylmethylammonium-1-yl, benzyldi-n-propylammonium-1-yl, benzylmethyl-n-propylammonium-1-yl, benzyldicyclohexylammonium-1-yl, benzylcyclohexylmethylammonium-1-yl, (3-nitrobenzyl)dimethylammonium-1-yl, or (3-methoxybenzyl)dimethylammonium-1-yl; or dialkyl(phenylalkyl)ammonium, such as dimethyl(phenylhexyl)ammonium-1-yl), and piperidinium (e.g., aliphatic piperidinium, such as 1-methyl-piperdinium-1-yl, 1,2-dialkyl-piperidinium, or 1,2-dimethyl-piperidinium-4-yl (DMP); or aromatic piperidinium, such as or 1-benzyl-1-methyl-piperidinium-4-yl (BMP), as well as any piperidinium cation described herein).

Such moieties can be associated with one or more counterions. For instance, a cationic moiety can be associated with one or more anionic counterions, and an anionic moiety can be associated with one or more cationic counterions.

### Arylene Groups

Particular moieties herein (e.g., polymeric units, linking moieties, and others) can include an optionally substituted arylene. Such arylene groups include any multivalent (e.g., bivalent, trivalent, tetravalent, etc.) groups having one or more aromatic groups, which can include heteroaromatic groups. Non-limiting aromatic groups can include any of the following.

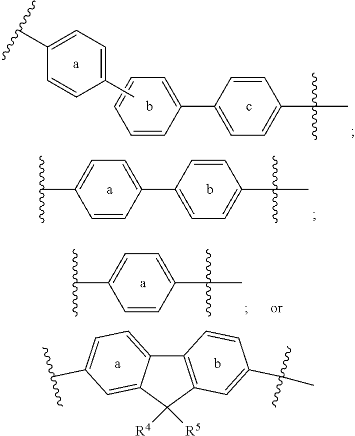

wherein:
each of R⁴ and R⁵ can, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or R⁴ and R⁵, together with the carbon atom to which they are attached, form an optionally substituted cyclic group;
each of ring a, ring b, and/or ring c can be optionally substituted; and
one or more of rings a-c optionally comprises an ionizable moiety or an ionic moiety; and in which each of rings a-c can be optionally substituted (e.g., with any optional substituents described herein for alkyl or aryl; or with any ionic moiety described herein).

Other non-limiting arylene can include phenylene (e.g., 1,4-phenylene, 1,3-phenylene, etc.), biphenylene (e.g., 4,4′-biphenylene, 3,3′-biphenylene, 3,4′-biphenylene, etc.), terphenylene (e.g., 4,4′-terphenylene), 9,10-anthracene, naphthalene (e.g., 1,5-naphthalene, 1,4-naphthalene, 2.6-naphthalene, 2,7-naphthalene, etc.), tetrafluorophenylene (e.g., 1,4-tetrafluorophenylene, 1,3-tetrafluorophenylene), and the like.

### Linking Moieties

Particular chemical functionalities herein can include a linking moiety, either between the parent structure and another moiety (e.g., an ionic moiety) or between two (or more) other moieties. Linking moieties (e.g., L^{A}, L^{A}′, and others) can be any useful multivalent group, such as multivalent forms of optionally substituted aliphatic, optionally substituted heteroaliphatic, optionally substituted aromatic, or optionally substituted heteroaromatic.

Non-limiting linking moieties (e.g., L^{A} and L^{A}′) can include a covalent bond, a spirocyclic bond, —O—, —NR^{N1}—, —C(O)—, —C(O)O—, —OC(O)—, —SO₂—, optionally substituted alkylene, optionally substituted alkyleneoxy, optionally substituted haloalkylene, optionally substituted heteroalkylene, optionally substituted arylene, optionally substituted aryleneoxy, optionally substituted heterocyclyldiyl, —SO₂—NR^{N1}-Ak-, —(O-Ak)_{L1}-SO₂NR^{N1}-Ak-, -Ak-, -Ak-(O-Ak)_{L1}-, —(O-Ak)_{L1}-, -(Ak-O)_{L1}—, —C(O)O-Ak-, —Ar—, or —Ar—O—, as well as combinations thereof. In particular embodiments, Ak is an optionally substituted aliphatic, optionally substituted alkylene, or optionally substituted haloalkylene; R^{N1} is H or optionally substituted alkyl or optionally substituted aryl; Ar is an optionally substituted aromatic or optionally substituted arylene; and L1 is an integer from 1 to 3.

In some embodiments, the linking moiety is —(CH₂)_{L1}—, —O(CH₂)_{L1}—, —(CF₂)_{L1}—, —O(CF₂)_{L1}—, or —S(CF₂)_{L1}— in which L1 is an integer from 1 to 3. In other embodiments, the linking moiety is -Ak-O—Ar-Ak-O-Ak- or -Ak-O—Ar—, in which Ak is optionally substituted alkylene or optionally substituted haloalkylene, and Ar is an optionally substituted arylene. Non-limiting substituted for Ar includes —SO₂-Ph, in which Ph can be unsubstituted or substituted with one or more halo.

### Methods of Making a Polymer

The present disclosure also encompasses methods of making a polymer. One non-limiting method can include forming an initial polymer having a reactive group (e.g., halo or another leaving group) and substituting the reactive group with an ionic moiety, thereby providing an ionic polymer. Any useful synthetic scheme can be employed to provide such ionizable or ionic moieties, such as by way of sulfonation or oxidation to introduce such ionizable/ionic moieties, catalytic polymerization with monomers having such ionizable/ionic moieties, and the like.

A further step can include exchanging a counterion present in the ionic polymer with another counterion (e.g., exchanging a halide counterion for a hydroxide counterion). Yet other steps can include exposing the ionic polymer to a crosslinking reagent to form one or more crosslinker between a combination of polymeric units, ionizable moieties, or ionic moieties.

One example for making the ionic polymers described herein is described generally in Scheme I:

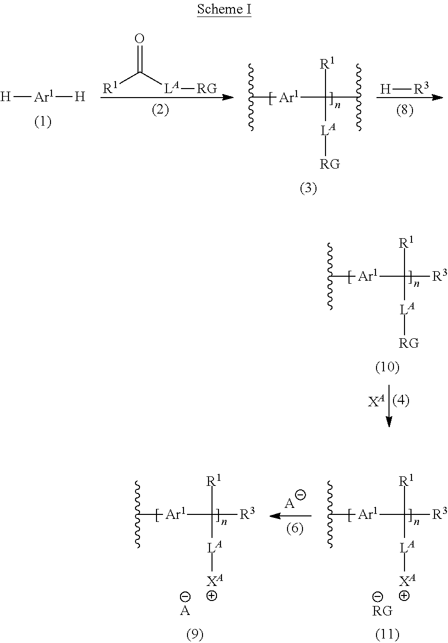

Scheme I provides a non-limiting reaction scheme for making a polymer. The reaction can proceed by providing a monomeric unit (1) (e.g., meta-terphenyl) comprising an optionally substituted arylene (—Ar¹—). Also provided is a non-limiting Friedel-Crafts acylation agent (2) (e.g., 7-bromo-1,1,1-trifluoroheptan-2-one) in the optional presence of a strong acid (e.g., methanesulfonic acid), which can be employed to react between the monomeric units (1). For instance, the Friedel-Crafts acylation agent can provide a carbocation intermediate having a haloalkyl or other electron-withdrawing moiety (e.g., R¹) and a reactive group (RG, e.g., halo) attached to the carbonyl carbon by way of a linking moiety (L^{A}). After the electrophilic addition reaction, the resulting initial polymer (3) includes the electron-withdrawing moiety (e.g., R¹) and the reactive group (RG) attached by way of a linking moiety L^{A} to a carbon in proximity to the arylene group (—Ar¹—). The polymerization reaction can then be terminated by adding a terminating agent (8) (e.g., R³, wherein R³ can be phenyl-(G¹)_{g}, wherein G¹ is C₁₋₁₀ alkyl, or OR^{X}, wherein R^{X} is H or C₁₋₁₀ alkyl; and g is a integer from 0 to 3). Further reactions can include contacting the reactive group RG with an example ionizable reagent (4), thereby providing an ionic polymer (11) having an ionic moiety (-X^{A}+). Yet another step can include exchanging a counterion (RG⁻) present in the ionic polymer with another counterion (A⁻) (6), thereby providing a further ionic polymer (7).

In one example, therefore, the compound of the formula (10) can be a compound of the formula (a):

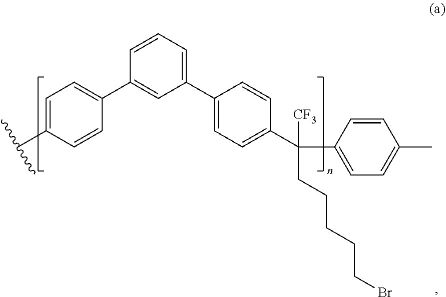

which can be converted to a compound of the formula (b) by reacting the compound of the formula (a) with an amine, such as trimethyl amine, to give the compound of the formula (b):

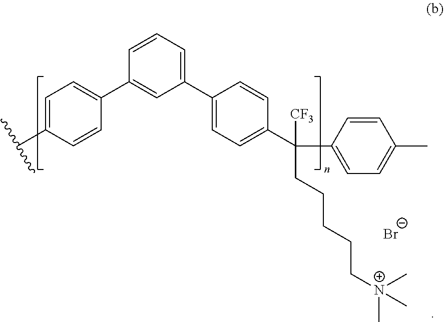

In some instances, the counterion (A⁻; in this case Br⁻) can be exchanged to a different counterion, such as bicarbonate, such as in compound (c):

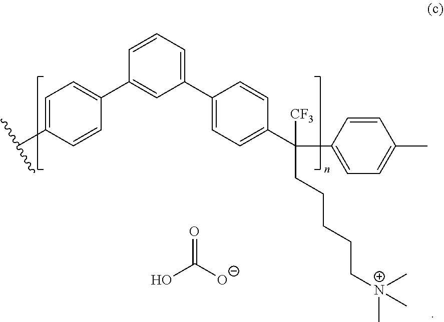

### Uses

The compositions described herein can be employed to form a material, such as a film, a membrane (e.g., an ion exchange membrane), or a crosslinked polymeric matrix. The composition and material thereof can be employed within a device or apparatus, such as an electrochemical cell. In one embodiment, the electrochemical cell includes an anode, a cathode, and a polymer electrolyte membrane (PEM) disposed between the anode and the cathode. The PEM (or a component thereof) can include any composition or material described herein.

The compositions herein can be employed as a component for a membrane electrode assembly (MEA). A non-limiting MEA can include a cathode layer having a reduction catalyst and a first ion-conducting polymer; an anode layer having an oxidation catalyst and a second ion-conducting polymer; a membrane layer having a third ion-conducting polymer between the anode layer and the cathode layer; and a cathode buffer layer having a fourth ion-conducting polymer between the cathode layer and the membrane layer. The membrane layer (e.g., PEM) can provide ionic communication between the cathode layer and the anode layer or can conductively connect the cathode layer and the anode layer. The cathode buffer layer can conductively connect the cathode layer and the membrane layer. Any of the polymers in the MEA (e.g., as a first, second, third, and/or fourth ion-conducting polymer) can include a composition as described herein.

In some embodiments, the cathode buffer layer has a first porosity between about 0.01 and 95 percent by volume (e.g., wherein the first porosity is formed by inert filler particles, such as diamond particles, boron-doped diamond particles, polyvinylidene difluoride (PVDF) particles, and polytetrafluoroethylene (PTFE) particles).

In other embodiments, at least two of the first, second, third, and fourth ion-conducting polymers are from different classes of ion-conducting polymers. There are three classes of ion-conducting polymers: anion-conductors, cation-conductors, and cation-and-anion-conductors. The ionic or ionizable moiety can be selected to provide any one of these classes.

The term. “ion-conducting polymer” is used herein to describe a polymer electrolyte having greater than approximately 1 mS/cm specific conductivity for anions and/or cations. The term, “anion-conductor” and/or “anion-conducting polymer” describes an ion-conducting polymer that conducts anions primarily (although there will still be some small amount of cation conduction) and has a transference number for anions greater than approximately 0.85 at around 100 micron thickness. The terms “cation-conductor” and/or “cation-conducting polymer” describe an ion-conducting polymer that conducts cations primarily (e.g., there can still be an incidental amount of anion conduction) and has a transference number for cations greater than approximately 0.85 at around 100 micron thickness. For an ion-conducting polymer that is described as conducting both anions and cations (a “cation-and-anion-conductor”), neither the anions nor the cations has a transference number greater than approximately 0.85 or less than approximately 0.15 at around 100 micron thickness. To say a material conducts ions (anions and/or cations) is to say that the material is an ion-conducting material.

The compositions herein can be employed in a reactor. Non-limiting reactors include an electrolyzer, a carbon dioxide reduction electrolyzer, a water electrolyzer, an electrochemical reactor, a gas-phase polymer-electrolyte membrane electrolyzer, but can additionally or alternatively include any other suitable reactors. The reactor may include one or more: electrodes (e.g., anode, cathode), catalysts (e.g., within and/or adjacent the cathode and/or anode), gas diffusion layers (e.g., adjacent the cathode and/or anode), and/or flow fields (e.g., defined within and/or adjacent the electrodes and/or gas diffusion layers, such as one or more channels defined opposing the cathode across the gas diffusion layer). In some embodiments, the reactor includes a membrane stack or membrane electrode assembly (MEA) having one or more polymer electrolyte membranes (PEMs), providing ionic communication between the anode and cathode of the reactor. In certain embodiments, the reactor includes a membrane stack including: a cathode layer including a reduction catalyst and an ion-conducting polymer; a PEM membrane (e.g., bipolar membrane, monopolar membrane, etc.; membrane including one or more anion conductors such as anion exchange membranes (AEMs), proton and/or cation conductors such as proton exchange membranes, and/or any other suitable ion-conducting polymers; membrane including one or more buffer layers; etc.); and an anode layer including an oxidation catalyst and an ion-conducting polymer. The ion-conducting polymers of each layer can be the same or different ion-conducting polymers. In particular embodiments, the membrane, membrane stack, membrane electrode assembly (MEA), polymer electrolyte membrane (PEM), and/or ion-conducting polymer includes a composition described herein.

In one embodiment, the carbon dioxide reduction electrolyzer includes a membrane electrode assembly (MEA). The MEA can include one or more ion-conducting polymer layers (e.g., including any composition described herein) and a cathode catalyst for facilitating chemical reduction of carbon dioxide to carbon monoxide.

In some configurations, a bipolar MEA has the following stacked arrangement: cathode layer/cathode buffer layer (an anion-conducting layer)/cation-conducting layer (with may be a PEM)/anode layer. In some implementations, the bipolar MEA has a cathode layer containing an anion-conducting polymer and/or an anode layer containing a cation-conducting layer. In some implementations, the bipolar MEA has an anode buffer layer, which may contain a cation-conducting material, between the cation-conducting layer and the anode layer. The cathode layer, cathode buffer layer, anion-conducting layer, cation-conducting layer, and/or anode layer can include any composition described herein.

In some configurations, a bipolar MEA has the following stacked arrangement: cathode layer/cation-conducting layer (with may be a PEM)/anion-conducting layer/anode layer. In some applications, a bipolar MEA having this arrangement is configured in a system for reducing a carbonate and/or bicarbonate feedstock such as an aqueous solution of carbonate and/or bicarbonate. The cathode layer, cation-conducting layer, anion-conducting layer, and/or anode layer can include any composition described herein.

In some configurations, an MEA has the following stacked arrangement: cathode layer/anion-conducting layer/bipolar interface/cation-conducting layer/anode layer. The bipolar interface can include, e.g., a cation-and-anion conducting polymer, a third polymer different from the polymers of the anion-conducting polymer layer and the cation-conducting polymer layer, a mixture of an anion-conducting polymer and a cation-conducting polymer, or a cross-linking of the cation-conducting polymer and anion-conducting polymer. The cathode layer, anion-conducting layer, bipolar interface, cation-conducting layer, and/or anode layer can include any composition described herein.

In some configurations, an MEA has the following stacked arrangement: cathode layer/anion-conducting layer/anode layer. In some implementations, this MEA has no cation-conducting layers between the cathode layer and the anode layer. In some applications, an MEA containing only anion-conducting material between the cathode and anode is configured in a system for reducing carbon monoxide feedstock. The cathode layer, anion-conducting layer, and/or anode layer can include any composition described herein.

The compositions herein can be provided in a layer (e.g., a membrane layer or others herein) having any suitable porosity (including, e.g., no porosity or a porosity between 0.01-95%, 0.1-95%, 0.01-75%, 1-95%, 1-90%, etc.). In some embodiments, the composition can provide a layer (e.g., a membrane) that is chemically and mechanically stable at a temperature ranging from room temperature (e.g., 25° C.) to 50° C. In other embodiments, the composition is soluble in a solvent used during fabrication of a layer (e.g., an organic solvent, such as dimethylsulfoxide, dichloromethane, tetrahydrofuran, and ethanol or mixtures thereof). In particular embodiments, the composition, a layer thereof, or a membrane thereof is characterized by an ion exchange capacity (IEC) from about 0.2 to 3 milliequivalents/g (meq/g), such as from 0.5 to 3 meq/g, 1 to 3 meq/g, or 1.1 to 3 meq/g. In some embodiments, the composition, a layer thereof, or a membrane thereof is characterized by a water uptake (wt. %) from about 2 to 180 wt. %, such as from 10 to 180 wt. %, 20 to 180 wt. %, 50 to 180 wt. %. 10 to 90 wt. %, 20 to 90 wt. %, or 50 to 90 wt. %. In other embodiments, the composition, a layer thereof, or a membrane thereof is characterized by an ionic conductivity of more than about 10 mS/cm. In any embodiment herein, a layer, a membrane, or a film including a composition herein has a thickness from about 10 to 300 μm, such as from 20 to 300 μm, 20 to 200 μm, or 20 to 100 μm. In any embodiment herein, the composition, a layer thereof, or a membrane thereof is characterized by minimal or no light absorbance at wavelength from about 350 nm to 900 nm, about 400 nm to 800 nm, or about 400 nm to 900 nm.

A layer or a membrane can be formed in any useful manner. In one embodiments, a composition (e.g., an initial polymer or an ionic polymer) can be dissolved in a solvent (e.g., any described herein, such as an organic solvent, including dimethylsulfoxide, dichloromethane, tetrahydrofuran, and ethanol or mixtures thereof)) to from a casting solution. The casting solution can be optionally filtered, applied to a substrate, and then dried to form a film. Application to a substrate can include doctor blade coating, solution casting, spraying, dip coating, spin coating, extrusion, melt casting, or a combination of any technique. The film can be optionally further treated, such as by immersion in any reagents herein (e.g., ionizable reagent, crosslinking reagent, counterion, solvent including water, etc., and combinations thereof).

Further uses, membranes, assemblies, and configurations are described in U.S. application Ser. No. 15/586,182, filed May 3, 2017, published as U.S. Pat. Pub. No. 2017-0321334, by Kuhl et al., entitled “Reactor with advanced architecture for the electrochemical reaction of CO₂, CO and other chemical compounds”: U.S. Appl. No. 63/060,583, filed Aug. 3, 2020, and International Appl. No. PCT/US2021/044378, filed Aug. 3, 2020, by Flanders et al., entitled “System and method for carbon dioxide reactor control”; and U.S. Appl. No. 62/939,960, filed Nov. 25, 2019, and International Publication No. WO 2021/108446, by Huo et al., entitled “Membrane electrode assembly for COₓ reduction,” each of which are incorporated herein by reference in its entirety.

Values expressed in a range format should be interpreted in a flexible manner to include not only the numerical values explicitly recited as the limits of the range, but also to include all the individual numerical values or sub-ranges encompassed within that range as if each numerical value and sub-range were explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting. Further, information that is relevant to a section heading can occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “substantially no” as used herein refers to less than about 30%, 25%, 20%, 15%, 10%, 5%, 3%, 2%, 1%, 0.5%, 0.1%, 0.05%, 0.001%, or at less than about 0.0005% or less or about 0% or 0%.

Those skilled in the art will appreciate that many modifications to the embodiments described herein are possible without departing from the spirit and scope of the present disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the foregoing description of or illustrative embodiments is provided for the purpose of illustrating the principles of the present disclosure and not in limitation thereof and can include modification thereto and permutations thereof.

What is claimed is:

1. A composition comprising a first structure of the formula: 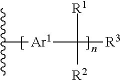
or a salt thereof, wherein:
each of R¹ and R² is, independently, an electron-withdrawing moiety, H, optionally substituted aliphatic, optionally substituted alkyl, optionally substituted heteroaliphatic, optionally substituted heteroalkyl, optionally substituted aromatic, optionally substituted aryl, or optionally substituted arylalkylene;
at least one of R¹ and R² comprises the electron-withdrawing moiety and at least one of R¹ and R² comprises an ionizable moiety or an ionic moiety; or
R¹ and R², together with the carbon atom to which they are attached, form a cyclic group optionally substituted with an ionizable moiety or an ionic moiety;
R³ is an optionally substituted aryl group;
Ar¹ is an optionally substituted aromatic group or optionally substituted arylene;
and n is an integer of 1 or more.

2. The composition of claim 1, wherein Ar¹ is: 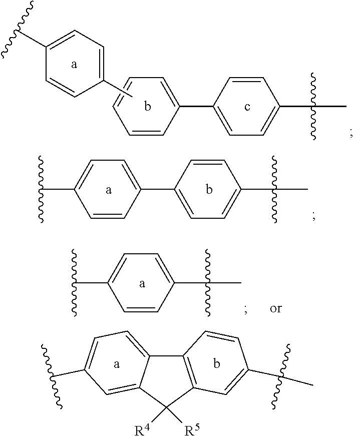
wherein:
each of R⁴ and R⁵ is, independently, H, optionally substituted aliphatic, optionally substituted alkyl, optionally substituted heteroaliphatic, optionally substituted heteroalkyl, optionally substituted aromatic, optionally substituted aryl, or optionally substituted arylalkylene, or R⁴ and R⁵, together with the carbon atom to which they are attached, form an optionally substituted cyclic group;
each of ring a, ring b, and/or ring c can be optionally substituted; and
one or more of rings a-c optionally comprises an ionizable moiety or an ionic moiety.

3. The composition of claim 1, wherein the first structure has the formula:

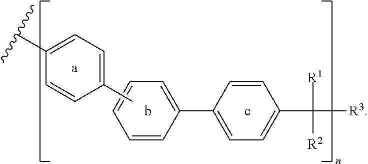

4. The composition according to claim 1, wherein the first structure has the formula:

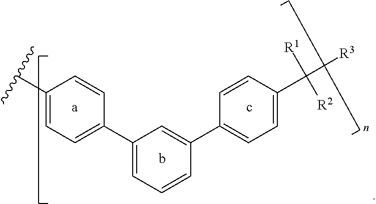

5. The composition according to claim 1, wherein R³ is: 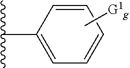
wherein G¹ is C₁₋₁₀ alkyl, or OR^{X}, wherein R^{X} is H or C₁₋₁₀ alkyl; and
g is a integer from 0 to 3.

6. The composition according to claim 1, wherein the electron-withdrawing moiety is an optionally substituted haloalkyl, cyano (CN), phosphate, sulfate, sulfonic acid, sulfonyl, difluoroboranyl, borono, thiocyanato, or piperidinium.

7. The composition according to claim 1, wherein the ionizable moiety or the ionic moiety includes -L^{A}-X^{A} or -L^{A}-(L^{A}′-X^{A})₂ or -L^{A}-(X^{A}-L^{A}′-X^{A}′)₂ or -L^{A}-X^{A}-L^{A}′-X^{A}′-L^{A}″-X^{A}″, wherein each L^{A}, L^{A}′, and L^{A}″ is a linking moiety; each X^{A}, X^{A}′, and X^{A}″ includes, independently, is an acidic moiety, a basic moiety, a multi-ionic moiety, a cationic moiety, or an anionic moiety; and
L² is an integer of 1 or more.

8. The composition of claim 7, wherein L^{A}, L^{A}′, and L^{A}″ includes, independently, an optionally substituted alkylene, optionally substituted alkyleneoxy, optionally substituted heteroalkylene, optionally substituted arylene, and/or optionally substituted aryleneoxy.

9. The composition of claim 7, wherein X^{A}, X^{A}′, and X^{A}″ includes, independently, sulfo, sulfonate anion, sulfonium cation, carboxy, carboxylate anion, phosphono, phosphonate anion, phosphonium cation, phosphazenium cation, amino, ammonium cation, heterocyclic cation, piperidinium cation or azepanium cation.

10. The composition according to claim 7, wherein L^{A}, L^{A}′, and L^{A}″ includes, independently, an optionally substituted alkylene.

11. The composition according to claim 7, wherein X^{A}, X^{A}′, and X^{A}″ includes, independently, amino or ammonium cation.

12. The composition according to claim 7, wherein R¹ is optionally substituted haloalkyl; and R² is optionally substituted aliphatic.

13. The composition according to claim 7, wherein R² is -L^{A}-X^{A}, wherein each L^{A} is optionally substituted aliphatic; each X^{A} includes, independently, a cationic moiety; and L² is an integer of 1 or more.

14. The composition of claim 13, wherein each L^{A} is optionally substituted alkylene.

15. The composition of claim 13, wherein L^{A} is optionally substituted C₁₋₁₀ alkyl.

16. The composition according to claim 13, wherein X^{A} is an ammonium cation.

17. The composition according to claim 1, wherein the first structure has the formula:

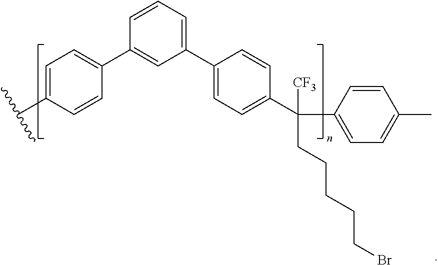

18. The composition according to claim 1, wherein the first structure has the formula:

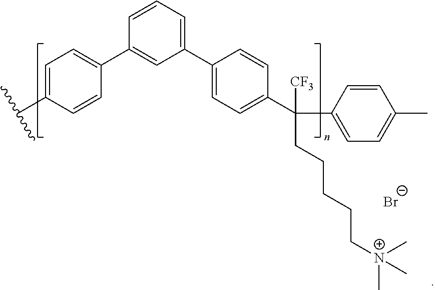

19. The composition according to claim 1, wherein the first structure has the formula:

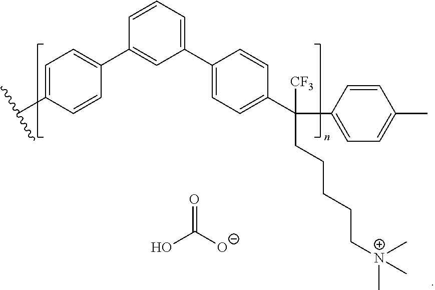

20. The composition of claim 1, wherein the first structure has a polydispersity index of less than 2.7 as determined by gel permeation chromatography (GPC).

21. An electrochemical cell comprising:
an anode;
a cathode; and
a polymer electrolyte membrane disposed between the anode and the cathode, wherein the polymer electrolyte membrane comprises a composition according to any of claim 1.

22. A method of making a polymer, the method comprising:
contacting monomeric units with a Friedel-Crafts acylation agent comprising a reactive group in the presence of a strong acid to give an initial polymer; and
contacting the initial polymer with a terminating agent to give a polymer comprising the first structure according to claim 1.

23. The method of claim 22, further comprising contacting the reactive group with an ionizable reagent to give an ionic polymer comprising a plurality of ionic moieties.

24. The method of claim 22, further comprising exchanging a counterion present in the composition with another counterion.

25. The method of claim 23, the ionic moiety is a cationic moiety.

26. The method according to claim 22, further comprising the step of contacting the polymer with methanol.

27. The method according to claim 26, wherein the contacting with methanol does not cause an exotherm.
